(19) United States
(12) Patent Application Publication
(10) Pub. No.: US 2026/0106787 A1
(43) Pub. Date: Apr. 16, 2026

(54) ANOMALY DETECTION IN CROSS-SYSTEM OPERATIONS

(71) Applicant: ADP, Inc., Roseland, NJ (US)

(72) Inventors: Bramaramba Mandulapally, Parsippany, NJ (US); Sreeshma Radhakrishnan, Parsippany, NJ (US); Jordi Salleras, Barcelona (ES); Ajjit Narayanan-satya, Parsippany, NJ (US)

(73) Assignee: ADP, Inc., Roseland, NJ (US)

(21) Appl. No.: 19/356,766

(22) Filed: Oct. 13, 2025

Related U.S. Application Data
(60) Provisional application No. 63/707,153, filed on Oct. 14, 2024.

(51) Int. Cl. H04L 41/0604; H04L 41/0859; H04L 47/125

(52) U.S. Cl. CPC H04L 41/0609; H04L 41/0859; H04L 47/125

(57) ABSTRACT

Anomaly detection in cross-system operation is provided. A system can generate, using machine learning, predicted values related to a network operation for an object identifier at a first time interval. The system can identify, from one or more systems of records, a plurality of actual values output responsive to execution of the network operation at the first time interval. The system can determine a variance in at least one value of the plurality of actual values based on a comparison of the plurality of actual values and the plurality of predicted values. The system can detect, using the one or more models, an anomaly in the variance. The system can execute, responsive to detection of the anomaly, an action to update the one or more models based on the anomaly.

### CROSS-REFERENCE TO RELATED APPLICATIONS

This application claims benefit and priority under 35 U.S.C. § 119 to U.S. Provisional Application No. 63/707,153, filed Oct. 14, 2024, the entirety of which is hereby incorporated by reference herein.

### TECHNICAL FIELD

This application is generally related to computing technology and, more particularly, to anomaly detection in cross-system operations.

### BACKGROUND

Various systems can be used to perform network operations. For example, one or more systems may include configuration information or settings, whereas other systems can execute some or all portions of an operation using the configuration or settings. However, as the configuration or settings become increasingly complex and interdependent, it can be challenging to efficiently and reliably execute a network operation without introducing errors, latencies, or redundant processes.

### SUMMARY

Aspects of the technical solutions described in the present application address technical challenges associated with detecting anomalies in cross-system operations. For example, in distributed computing environments, a computing system that executes operations across multiple systems of record, configuration services, or application modules experiences inconsistencies, processing latency, and reduced accuracy due to variations in configuration parameters, system settings, and update frequencies. As configuration complexity increases across heterogeneous computing environments, differences in platforms, data schemas, and orchestration mechanisms can lead to redundant executions, synchronization latency, and propagation inefficiencies, thereby resulting in reduced computational efficiency and increased resource utilization. Moreover, in large-scale computing environments, such as multi-region computing systems, interdependencies among region-specific datasets and regulatory compliance parameters further increase processing latency and reduce computational accuracy. Consequently, computing systems that lack scalable anomaly detection and configuration validation processes experience increased processing latency, inefficient utilization of computing resources, and diminished operational reliability during large-scale cross-system operations.

The technical solutions described herein implement scalable anomaly detection and operation validation across heterogeneous computing environments using machine learning predictive techniques and historical operational data. For example, in response to a request to execute a cross-system operation, a computing system can access operational records, configuration parameters, and update histories from one or more systems of record. The computing system can generate, using one or more models trained with machine learning on historical operational data, a plurality of predicted values related to the operation for an object identifier at a selected time interval to forecast operational outcomes and reduce execution latency. The computing system can identify, from the systems of record, a plurality of actual values output responsive to execution of the operation at the selected time interval to monitor operational performance in real-time or near-real-time. The computing system can determine a variance in at least one value of the plurality of actual values based on a comparison of the plurality of actual values and the plurality of predicted values to quantify deviations from expected outcomes and improve computational accuracy. The computing system can detect, using the one or more models, an anomaly in the variance and enhance reliability and operational integrity during large-scale cross-system operations. The computing system can execute, responsive to detection of the anomaly, an action to update the one or more models based on the anomaly to refine predictive accuracy, optimize resource allocation, and dynamically improve the model's ability to process heterogeneous operational data in subsequent executions.

The technical solutions described herein further provide filtering of noisy, inaccurate, or irrelevant data, normalization of configuration parameters, and enrichment with metadata such as timestamps, system identifiers, geographic region codes, client identifiers, and update frequencies to improve interoperability and support accurate evaluation across heterogeneous computing environments. The computing system can transform raw operational data from one or more systems of record into structured representations, apply predictive modeling to anticipate subsequent operational states, and trigger adaptive validation workflows to reduce redundant executions, minimize synchronization latency, and optimize propagation across distributed computing environments. Statistical and machine learning techniques, including conformal prediction, cross-validation, bounds calculation, and seasonality-aware prediction intervals, can also be applied to refine predictive models and improve computational accuracy for large-scale cross-system operations. Collectively, the technical solutions described herein transform and evaluate operational data, detect anomalies, and adapt predictive models to validate and optimize cross-system operations, thereby reducing execution latency, enhancing computational efficiency, improving computational accuracy, and optimizing utilization of network resources across large-scale operations.

An aspect of the technical solutions described herein can be directed to a system. The system can include one or more processors coupled with memory. The system can generate, using one or more models trained with machine learning on data collected from one or more systems of records associated with historical network operations, a plurality of predicted values related to a network operation for an object identifier at a first time interval. The system can identify, from the one or more systems of records, a plurality of actual values output responsive to execution of the network operation at the first time interval. The system can determine a variance in at least one value of the plurality of actual values based on a comparison of the plurality of actual values and the plurality of predicted values. The system can detect, using the one or more models, an anomaly in the variance. The system can execute, responsive to detection of the anomaly, an action to update the one or more models based on the anomaly.

In some cases, the system can generate the plurality of predicted values using the one or more models configured with conformal prediction. The system can generate the plurality of predicted values using the one or more models configured with cross-validation across the data associated with the historical network operations. The system can determine an upper bound and a lower bound based on the conformal prediction. The system can determine the variance based on the at least one value falling outside the upper bound and the lower bound.

In some cases, the data collected from the one or more systems of records are associated with the historical network operations for the object identifier. The system can determine, using the one or more models, a severity of the variance. The system can detect the anomaly based on the severity of the variance. In some cases, the system can determine, using the one or more models, a relevance of the variance. The system can detect the anomaly based on the relevance and the severity of the variance.

The system can execute the action comprising to provide, for display via a graphical user interface, an indication of the anomaly. The system can receive, responsive to an interaction with the graphical user interface, an indication to invalidate the anomaly, wherein invalidating the anomaly validates the variance. The system can update the one or more models based on the invalidation of the anomaly to control a performance of the one or more models with detection of anomalies associated with subsequent network operations. In some cases, the system can receive the interaction comprising natural language text input. The system can update the one or more models based on the natural language text input.

The system can execute the action comprising to provide, for display via a graphical user interface, an indication of the anomaly. The system can receive, responsive to an interaction with the graphical user interface, an indication to validate the anomaly, wherein validating the anomaly invalidates the variance. The system can update the one or more models based on the validation of the anomaly to control a performance of the one or more models with detection of anomalies associated with subsequent network operations.

The system can trigger, based on a load balancing technique, an anomaly detection process for the network operation at the first time interval. The system can execute, responsive to the trigger, the anomaly detection process to detect the anomaly in the variance. The system can detect the anomaly in the variance based on an audit log for the object identifier.

An aspect of the technical solutions described herein can be directed to a method. The method can be performed by one or more processors, coupled with memory. The method can include the one or more processors generating, using one or more models trained with machine learning on data collected from one or more systems of records associated with historical network operations, a plurality of predicted values related to a network operation for an object identifier at a first time interval. The method can include the one or more processors identifying, from the one or more systems of records, a plurality of actual values output responsive to execution of the network operation at the first time interval. The method can include the one or more processors determining a variance in at least one value of the plurality of actual values based on a comparison of the plurality of actual values and the plurality of predicted values. The method can include the one or more processors detecting, using the one or more models, an anomaly in the variance. The method can include the one or more processors executing, responsive to detection of the anomaly, an action to update the one or more models based on the anomaly.

An aspect of the technical solutions described herein can be directed to a non-transitory computer-readable medium storing processor executable instructions that, when executed by one or more processors, cause the one or more processors to generate, using one or more models trained with machine learning on data collected from one or more systems of records associated with historical network operations, a plurality of predicted values related to a network operation for an object identifier at a first time interval. The instructions can cause the one or more processors to identify, from the one or more systems of records, a plurality of actual values output responsive to execution of the network operation at the first time interval. The instructions can cause the one or more processors to determine a variance in at least one value of the plurality of actual values based on a comparison of the plurality of actual values and the plurality of predicted values. The instructions can cause the one or more processors to detect, using the one or more models, an anomaly in the variance. The instructions can cause the one or more processors to execute, responsive to detection of the anomaly, an action to update the one or more models based on the anomaly.

### BRIEF DESCRIPTION OF THE DRAWINGS

These and other aspects and features of the present implementations are depicted by way of example in the figures discussed herein. Present implementations can be directed to, but are not limited to, examples depicted in the figures discussed herein. Thus, this innovation is not limited to any figure or portion thereof depicted or referenced herein, or any aspect described herein with respect to any figures depicted or referenced herein.

FIG. 1 depicts an example system for anomaly detection in cross-system operations, in accordance with some implementations.

FIG. 2 depicts an example machine learning architecture for anomaly detection in cross-system operations, in accordance with some implementations.

FIG. 3 depicts an example operational system architecture for anomaly detection in cross-system operations, in accordance with some implementations.

FIG. 4 depicts an example graph related to anomalies, in accordance with some implementations.

FIG. 5 depicts an example graph related to anomalies, in accordance with some implementations.

FIG. 6 depicts an example graph related to anomalies, in accordance with some implementations.

FIG. 7 depicts an example graph related to anomalies, in accordance with some implementations.

FIG. 8 depicts an example graph related to anomalies, in accordance with some implementations.

FIG. 9 depicts an example graphical user interface, in accordance with some implementations.

FIG. 10 depicts an example graphical user interface, in accordance with some implementations.

FIG. 11 depicts an example graphical user interface, in accordance with some implementations.

FIG. 12 depicts an example graphical user interface, in accordance with some implementations.

FIG. 13 depicts an example graphical user interface, in accordance with some implementations.

FIG. 14 depicts an example graphical user interface, in accordance with some implementations.

FIG. 15 depicts an example method for anomaly detection in cross-system operations, in accordance with some implementations.

FIG. 16 depicts a block diagram of an example computing system for implementing the embodiments of the present solution, including, for example, the systems depicted in FIG. 1, FIG. 2, and FIG. 3, the method depicted in FIG. 15, and the graphical user interfaces, dashboards, or graphs depicted in FIGS. 4-14.

### DETAILED DESCRIPTION

Aspects of the technical solutions described herein with reference to the figures, which are illustrative examples of this technical solution. The figures and examples below are not meant to limit the scope of the technical solutions to the present implementations or to a single implementation, and other implementations in accordance with present implementations are possible, for example, by way of interchange of some or all of the described or illustrated elements. Where certain elements of the present implementations can be partially or fully implemented using known components, only those portions of such known components that are necessary for an understanding of the present implementations are described, and detailed descriptions of other portions of such known components are omitted to not obscure the present implementations. Terms in the specification and claims are to be ascribed no uncommon or special meaning unless explicitly set forth herein. Further, the technical solutions and the present implementations encompass present and future known equivalents to the known components referred to herein by way of description, illustration, or example.

Aspects of technical solutions described herein are directed to scalable anomaly detection in cross-system operations. Due to increasingly varied and complex configuration parameters or settings used or updated by various systems, it can be challenging to efficiently and reliably execute a network operation without introducing errors, latencies, or redundant processes. For example, in a complex transaction processing computing environment, such as a multi-country computing environment, it can be challenging to reliably and efficiently scale network operations across systems of record. To address these or other technical problems, the technical solutions described herein detect anomalies and provide accurate validation of network operations using machine learning predictive techniques and historical data.

Certain network operations can include or form functions within a computing infrastructure. For example, payroll processing can be a core function. However, validating payroll data can be computationally intensive, with collecting and reconciling data from various heterogeneous sources or systems of record leading to security vulnerabilities, errors, and high resource utilization.

Technical solutions described herein can streamline validation processes, thereby reducing errors, enhancing compliance, and providing other useful insight and actions. For example, a data processing system described herein can execute a network operation such as payroll processing, using artificial intelligence or machine learning capabilities to predict different payroll constructs of employees such as salary, net pay, earnings, or deductions. The data processing system can generate predictions using historical data. The data processing system can compare the predicted amount with the actual amount received for the given wage types to detect anomalies and data patterns before the payroll operation is executed. By using data-driven models, the data processing system can reduce the processing latency for rule configuration and improve the computational efficiency of an operation framework. The data processing system can proactively or automatically detect anomalies and patterns during payroll processing. The data processing system can detect anomalies in various heterogeneous systems of record. In an example use case, the data processing system can forecast transaction values, such as wage amounts, for pay components at an employee or object level based on historical data of the employee. To do so, the data processing system can use the client identifier, region, country, employee identifier, operation code, wage code, pay start date, and pay frequency as the key features for the model. The model can include time series forecasting to forecast the amounts of the various pay constructs or wage types. In some cases, the data processing system can use an ARIMA (autoregressive integrated moving average) model or an auto-ARIMA model implemented via a Statsforecast framework for time series predictions.

Time series forecasting can refer to or include a statistical modeling technique used to make predictions about future values based on historical and present data in a time-ordered sequence. In a time series, data points can be collected at regular intervals, such as hourly, daily, monthly, or yearly, and the goal of forecasting is to estimate future values in the sequence. Methods of forecasting can range from simple approaches, such as moving averages, to more complex methods, including ARIMA models or auto-ARIMA models. In an example use case, suppose an employee has been getting paid 100-120 dollars net pay every month for the last 6 months. In such instances, there is a high probability that the employee will be paid 100-120 dollars next month as well. Using historical data for each of the pay elements, the data processing system can predict or forecast the amount for the pay element in the next pay period. Such an approach can be extended not only to net pay but also to other pay constructs such as deductions, earnings, and gross pay. To perform anomaly detection in time series forecasting, the data processing system can identify unusual or abnormal data points within a time-ordered sequence. Such unusual data points, or anomalies, deviate significantly from expected or regular patterns in the time series. The objective of anomaly detection is for the data processing system to identify such deviations, which can indicate errors or events in the data or unexpected operational behavior.

The data processing system can obtain the data used to train the model from one or more data sources, data repositories, databases, or a federated data platform implemented on a scalable cloud-based architecture. The data processing system can support application development, data analysis, model building, and data sharing. The data can be ingested by the SOR (system of record). For any entity within an SOR, the initial data can be ingested first, which can include the historical data of the client, and then by a pipeline that can ingest ongoing data. SORs can ingest the data and preprocess or train the data for predictive modeling. Operational data from multiple sources, including human resource (HR) data, foundation data, and payroll data, can be ingested into the data processing system. The data can be preprocessed and filtered to extract the feature set for model training. The data elements used for training the model are illustrated in the example below.

The table below shows an example of gross pay with wage type (e.g., /101) of an employee over a period of time.

| | | | Client | | | |
|---|---|---|---|---|---|---|
| Country | Period start | Client | employee | Wage | Wage | |
| code | date | ID | ID | type | amount | Pay frequency |
| US | YYYY-05-08 | xyx | E1234 | /101 | 40384.62 | 04-Bi-Weekly |
| US | YYYY-04-24 | xyx | E1234 | /101 | 659018.36 | 04-Bi-Weekly |

The data processing system can ingest the data using connectors, including, for example, application programming interfaces (APIs), flat files, or data streams. The transaction or operational data from an SOR application can be persisted into a data store, such as a relational or object store, and then ingested into the data processing system. The data processing system can leverage custom extractions, or predefined extractions, files, streams, real-time, batch mode, a speed layer, historical load, and on-going load. The SOR can ingest several years of data, such as four to five years. For training the machine learning models, the data processing system can use a feature set that includes, for example, client identifier, country, employee identifier, pay frequency, pay start date, pay end date, wage type identifier, wage type category, or wage amount. The data processing system can predict wage types such as gross pay, net pay, earnings, and deductions. To reduce the noise and improve the relevancy of the anomalies that are detected, the data processing system can configure wage types by country or region. For accurate forecasting and prediction, the data processing system can use at least six months of data. The data processing system can filter out an object identifier's data that is less than six months old, as it can result in inaccurate forecasting.

The data processing system can use an ARIMA model or an auto-ARIMA model. ARIMA can refer to or include a statistical analysis model that uses time-series data to process the data set and predict future trends. A statistical model is autoregressive if the model can predict or generate future values based on past values. The data processing system can use the auto-ARIMA model, which can refer to an automated version of the ARIMA model, to determine the optimal parameters for the time-series data. The data processing system can train the auto-ARIMA model using the StatsForecast package. StatsForecast can refer to or include a package, including a collection of statistical and econometric models to forecast univariate time series, which can improve the performance of models. The data processing system can develop the models using a platform that can manage the machine learning lifecycle, including experimentation, reproducibility, deployment, and a central model registry. The data processing system, using the trained model, can make predictions for multiple horizons or pay periods, such as 2 horizons, 3 horizons, or more. The data processing system can use feedback to improve the model. The data processing system can use conformal prediction intervals to provide prediction intervals along with point forecasts. Such an approach can facilitate quantifying the uncertainty in the wage amount predictions, allowing the data processing system to estimate a range of possible values rather than just a single point prediction. The data processing system can use upper and lower prediction intervals to identify anomalies. The data processing system can identify actual wage amounts that fall outside the upper or lower intervals as anomalies. For example, a gross pay that is significantly lower or higher than the upper or lower prediction levels can indicate an anomaly.

The data processing system can identify variations in the time series as features. Variations can correspond to patterns in the time series data. A time series with patterns that repeat over known and fixed periods of time is said to have seasonality. Seasonality can refer to variations that periodically repeat in the data. For payroll constructs, the data processing system can detect seasonality, for example, yearly performance cycles that result in an increase in amounts across various payroll constructs. The data processing system can take into account seasonality while training the data. For monthly payroll, the data processing system can set the seasonality length to twelve intervals, allowing the data processing system to identify a trend or increase in data after twelve pay periods. For biweekly payroll operations, the data processing system can set the seasonality length to twenty-six intervals (or pay periods in a year), since the frequency of data is every fourteen days. The data processing system can evaluate the performance of the model using mean absolute error and root mean squared error that assess the computational accuracy of predictions.

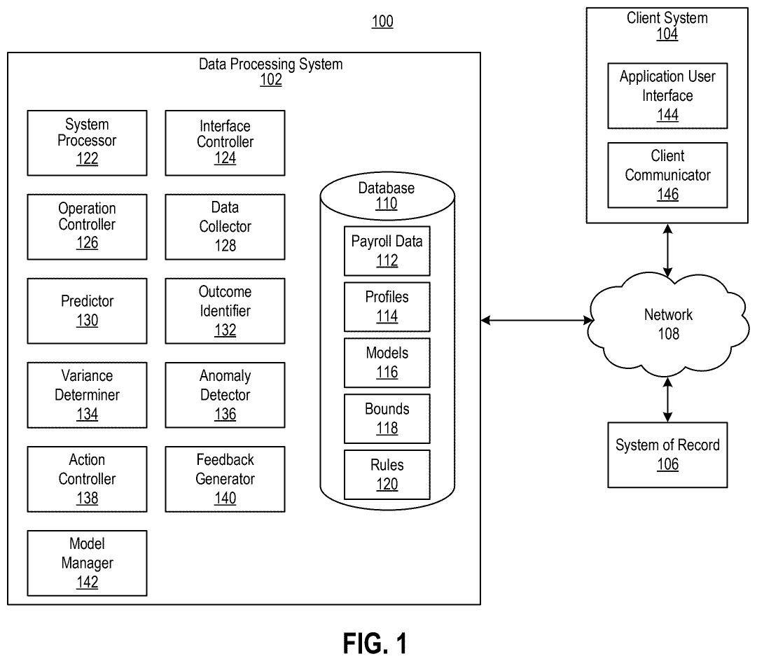

FIG. 1 depicts an example system according to one or more aspects of the technical solutions described herein. As illustrated by way of example in FIG. 1, a system 100 can include one or more components, such as a data processing system 102, a client system 104, and a system of record 106. One or more components of the system 100 can communicate via network 108.

The data processing system 102 can include computing resources configured to execute data processing operations and manage workflows. The data processing system 102 can include a physical computer system operatively coupled or couplable with one or more components of the system 100. The data processing system 102 can include, host, or be hosted by or on a cloud system, a server, a distributed remote system, or any combination thereof. The data processing system 102 can include a virtual computing system, an operating system, and a communication bus to effect communication and processing. The data processing system 102 can include physical infrastructure, such as physical servers, storage devices, and network equipment housed in data centers. The data processing system 102 can include a virtual computing system, which can include cloud-based virtual machines or containers for running applications and services. The data processing system 102 can include an operating system that can function as the core manager, allocating resources, configuring processes, and maintaining seamless interaction between hardware and applications. The data processing system 102 can include a communication bus that can facilitate communication between different components within the system. The data processing system 102 can be configured to connect with external systems to allow for data exchange and service delivery to end users.

The data processing system 102 can be, include, execute, or host a payroll system configured to manage employee compensation, deductions, tax calculations, and other payroll-related updates. The data processing system 102 can be, include, execute, or host a human resource (HR) system configured to manage employee information, including personal details, job history, performance reviews, benefits enrollment, and beneficiary designations, among others. The data processing system 102 can be or include a time and benefits administration system configured to manage employee time tracking, leave requests, vacation time, sick leave, and changes to benefits selections, among others. The data processing system 102 can be a more generalized administrative system that incorporates functionalities from multiple domain-specific systems. The architecture and configuration of the data processing system 102 can be determined based on organizational requirements, data complexity, and the level of interoperability desired between various administrative functions.

The client system 104 (also referred to herein as a client device 104) can include a computing system that can be used to access the functionality of the data processing system 102 and the system of record 106. The client system 104 can include a smart phone, mobile device, laptop computer, desktop computer, one or more servers, or any other type of computing device. The client system 104 can include at least one processor and a memory, e.g., a processing circuit. The memory can store processor-executable instructions that, when executed by the processor, cause the processor to perform one or more of the operations described herein. The processor can include a microprocessor, an ASIC, an FPGA, etc., or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, ROM, RAM, EEPROM, EPROM, flash memory, optical media, or any other suitable memory from which the processor can read instructions. The instructions can include code from any suitable computer programming language.

The client system 104 can include one or more devices to receive input from a user or to provide output to a user. For example, the output capabilities of the client system 104 can be presented through a display device that provides visual feedback to the user. The display device can enhance the user experience with electronic displays, such as liquid crystal displays (LCD), light-emitting diode (LED) displays, or organic light-emitting diode (OLED) displays. The electronic displays can implement interactive features, including capacitive or resistive touch input, allowing for multi-touch functionality. The input functionalities can include a keyboard, mouse, or an integrated touch-sensitive panel on the display device, but are not limited thereto.

Each client device 104 can be associated with an identifier used to identify devices or user profiles operating the client devices 104. The identifier can be of one or more forms, such as a device ID, which can be a code assigned to the client device 104 by the manufacturer or operating system, a MAC address, which can be a hardware address assigned to the client device's network interface, or an IP address, which can identify the client device 104 on a network. The identifier can be a user ID associated with the user profile operating the client device 104, or a session ID, which can be a temporary identifier assigned to a specific session. Other identifiers, such as a serial number, can be used depending on the system and device configuration. The identifiers can facilitate the management of logically partitioned data segments and client-specific configurations within a multi-tenant computing environment based on attributes such as user identity, session context, device-specific parameters, or system-defined rules.

A system of record 106 can include any computing system, database, application, repository, or other data source configured to maintain, store, or otherwise manage data associated with historical network operations. The one or more systems of records 106 (also referred to herein as a system of record 106) can receive data from multiple data sources, repositories, databases, client-specific data feeds, or a federated data platform implemented on a scalable cloud-based architecture. For example, the system of record 106 can store transactional, operational, or event data related to processes such as multi-country payroll processing, benefits administration, tax computation, HR operations, regulatory reporting, or other domain-specific network operations. Operational data from multiple data sources, including personnel records, foundational system data, payroll data (e.g., client identifier, country code, pay frequency, pay start date, pay end date, wage type identifier, wage type category, wage amount), seasonal payroll adjustments, and financial transaction data, can be ingested into the system of record 106.

The data stored within the system of record 106 can be associated with one or more object identifiers, such as identifiers specifying an object, employee, device, account, service instance, payroll batch, multi-country transaction batch, or another entity being monitored. The system of record 106 can ingest the data using connectors, including APIs, flat files, or data streams, and can normalize and validate ingested records against a standardized multi-region schema before persisting the data into a data store, such as a relational or object store, for further processing. The system of record 106 can provide access to historical data at various levels of granularity, including per-event, per-period, per-entity, or aggregated data across specified time intervals.

The system of record 106 can store multiple years of data, such as four to five years, and can maintain the data for use in preprocessing or training models in downstream applications. Such historical datasets can support feature extraction for time-series forecasting, conformal prediction bound calculation, seasonality-aware anomaly detection, and compliance-specific variance evaluation. The system of record 106 can include multiple federated or distributed data sources located across different geographies, which can be queried individually or in combination via APIs, data integration platforms, or other techniques to acquire historical data for use in validation workflows, severity or relevance scoring, machine learning model training, predictive analytics, anomaly detection, and multi-jurisdiction compliance evaluations.

The network 108 can include any type or form of network. The geographical scope of the network 108 can vary widely, and the network 108 can include a body area network (BAN), a personal area network (PAN), a local-area network (LAN), e.g., Intranet, a metropolitan area network (MAN), a wide area network (WAN), or the Internet. The topology of the network 108 can be of any form and can include, e.g., any of the following: point-to-point, bus, star, ring, mesh, or tree. The network 108 can include an overlay network that is virtual and sits on top of one or more layers of other networks 108. The network 108 can be of any such network topology as known to those ordinarily skilled in the art capable of supporting the operations described herein. For example, the network 108 can be any form of computer network that can relay information among the data processing system 102, the client system 104, and the system of record 106. The network 108 can utilize different techniques and layers or stacks of protocols, including, e.g., the Ethernet protocol, the Internet protocol suite (TCP or IP), the ATM (Asynchronous Transfer Mode) technique, the SONET (Synchronous Optical Networking) protocol, or the SD (Synchronous Digital Hierarchy) protocol. The TCP or IP Internet protocol suite can include the application layer, transport layer, Internet layer (including, e.g., IPV6), or the link layer. The network 108 can include a type of broadcast network, a telecommunications network, a data communication network, or a computer network.

The data processing system 102 can include, access, interface with, communicate with, or otherwise utilize a database 110. The database 110 can be a computer-readable memory that can store or maintain any of the information described herein. The database 110 can store data associated with the system 100. The database 110 can include one or more hardware memory devices to store binary data, digital data, or the like. The database 110 can include one or more electrical components, electronic components, programmable electronic components, reprogrammable electronic components, integrated circuits, semiconductor devices, flip flops, arithmetic units, or the like. The database 110 can include at least one of a non-volatile memory device, a solid-state memory device, a flash memory device, or a NAND memory device. The database 110 can include one or more addressable memory regions disposed on one or more physical memory arrays. A physical memory array can include a NAND gate array disposed on, for example, at least one of a particular semiconductor device, an integrated circuit device, or a printed circuit board device. In some cases, the database 110 can correspond to a non-transitory computer readable medium. In some cases, the non-transitory computer readable medium can include one or more instructions executable by a system processor 122.

The database 110 can store or maintain one or more data structures, which can include containers (such as tables, arrays, or linked lists), indices, or otherwise store each of the values, pluralities, sets, variables, vectors, numbers, or thresholds described herein. The database 110 can be accessed using one or more memory addresses, index values, or identifiers of any item, structure, or region maintained in the database 110. The database 110 can be accessed by the components of the data processing system 102, the client system 104, the system of record 106, or any other computing device described herein via the network 108. The database 110 can be internal to the data processing system 102. The database 110 can exist externally to the data processing system 102 and can be accessed via the network 108. The database 110 can be remote from the client system 104 and can be accessed over the network 108. For example, the database 110 can be distributed across many different computer systems (e.g., a cloud computing system) or storage elements and can be accessed via the network 108 or a suitable computer bus interface.

The database 110 can ingest data using connectors, including, for example, APIs, flat files, or data streams. Transactional or operational data from the system of record 106 can be persisted into a data store, such as a relational or object store, before being ingested into the database 110. The system of record 106 can maintain and provide several years of historical data, such as four to five years, for use in downstream processing. The database 110 can store and organize feature sets that can include, for example, client identifier, country code, employee identifier, pay frequency, pay start date, pay end date, wage type identifier, wage type category, and wage amount. To improve forecasting accuracy and enhance the relevancy of anomaly detection, the database 110 can maintain data for a minimum period, such as six months (or a configurable interval), and can filter out object identifiers with less than the minimum historical data threshold.

The database 110 can include, maintain, or otherwise store payroll data 112. The payroll data 112 can refer to any information, records, or data elements associated with payroll operations for one or more object identifiers, such as employees, payroll batches, positions, departments, or other entities relevant to compensation or benefits processing. The payroll data 112 can be ingested from one or more data sources, data repositories, databases, or client-specific or multi-country federated data platforms implemented on a scalable cloud-based architecture. The payroll data 112 can include structured, semi-structured, or unstructured datasets normalized for multi-region processing, relating to salaries, wages, bonuses, deductions, allowances, reimbursements, contributions, tax withholdings, or other compensation-related amounts. The payroll data 112 can include contextual data such as pay period dates, pay frequency, work location, job classification, benefits enrollment, leave balances, performance records, employment status changes, or jurisdiction-specific regulatory compliance indicators. The payroll data 112 can include identifiers such as client identifiers, country codes, employee identifiers, job codes, wage type identifiers, or payroll batch identifiers. Such data can be stored in native payroll processing formats, validated against standardized multi-region schemas, normalized to a common schema, or associated with other operational datasets. The payroll data 112 can include any domain-specific data used in payroll processing, variance detection, anomaly detection, or machine learning model training, including features for time-series forecasting, seasonal adjustment parameters, and bound calculations or determinations for anomaly classification. While the payroll data 112 is provided as an example of the type of information stored within the database 110, the database 110 can include other operational data in addition to or instead of payroll-related information, such as human resources records, finance transactions, or regulatory compliance data.

The database 110 can include, maintain, or otherwise store profiles 114. The profiles 114 can refer to any collection of data, attributes, or metadata associated with a particular object identifier, such as an employee, payroll batch, client account, device, service instance, or other monitored entity. The profiles 114 can include static data or records (e.g., name, identifier codes, role, or geographic location) and dynamic or historical data (e.g., past transactions, operational events, historical payroll amounts, benefit enrollment history, or performance metrics). The profiles 114 can include domain-specific fields depending on the operational context. For example, in payroll processing instances, the profiles 114 can store employment details such as job title, department, hire date, compensation structure, benefit selections, leave entitlements, payroll history, allowance eligibility, and tax jurisdiction, among others. In other contexts, the profiles 114 can include configuration parameters, usage statistics, service levels, or compliance data for the corresponding object identifier. The profiles 114 can be used or processed by various components of the data processing system 102 for prediction, variance detection, anomaly detection, rules evaluation, or machine learning model training. The profiles 114 can be associated with other datasets such as payroll data, audit logs, or rule definitions.

The database 110 can include, maintain, or otherwise store models 116, where a model 116 can refer to a machine learning model 116 configured to process historical data, predict future values, detect anomalies, or otherwise assist in automated inference or control operations within the data processing system 102. The model 116 can be deployed within the data processing system 102 or externally as remote services. The models 116 can operate across single-jurisdiction or multi-country computing environments to accommodate differing rules, payroll frequencies, and compliance requirements. The models 116 can include, by way of example, neural networks such as generative adversarial networks including a generator neural network and a discriminator neural network that are trained simultaneously through adversarial training, variational autoencoders that learn to generate new data samples by modeling the underlying probability distribution of the input data, autoregressive models for sequential data prediction, or other forms of neural network architectures such as deep learning models, convolutional neural networks, recurrent neural networks, and transformers. The transformers can refer to or include deep learning model architectures configured for sequence modeling or natural language processing, including, but not limited to, bidirectional encoder representations from transformers (BERT), generative pre-trained transformers (GPT), text-to-text transformers (T5), transformer-XL, robustly optimized BERT, or distilled BERT.

Additional machine learning techniques used for the models 116 can include supervised learning models, unsupervised learning models, semi-supervised learning models, reinforcement learning models, or any combination thereof. The models 116 can be constructed, trained, and deployed using historical datasets obtained from one or more systems of record 106, operational logs, payroll data 112, bounds 118, rules 120, audit logs, and contextual metadata such as client identifier, country code, pay frequency, pay start date, pay end date, wage type identifier, wage type category, seasonal adjustment parameters, and compliance-related fields.

The models 116 can incorporate time-series forecasting techniques, conformal prediction methods for upper and lower bounds determination, cross-validation across historical datasets to improve accuracy and robustness, and anomaly scoring algorithms that combine severity and relevance metrics. The models 116 can be updated based on real-time or near-real-time feedback, user interactions, structured annotations, natural language text detected via application user interface 144, or automated retraining triggers. The models 116 can operate in conjunction with components such as the predictor 130, outcome identifier 132, variance determiner 134, anomaly detector 136, and model manager 142 to support continuous improvement in forecasting precision, anomaly detection effectiveness, and compliance validation.

The model 116 can include or utilize an auto-ARIMA (automated autoregressive integrated moving average) model to perform time-series forecasting based on historical operational data. ARIMA can refer to a statistical analysis model that uses time-ordered data points to process datasets or predict future trends, where autoregressive methods forecast future values based on observed past values. The auto-ARIMA implementation can automatically determine optimal model parameters for a given time-series dataset and can be trained using the StatsForecast package, which includes a collection of statistical and econometric forecasting models optimized for univariate time series and configured to improve prediction performance. The model 116 can be developed and managed using a platform that supports the machine learning lifecycle, including experimentation, reproducibility, deployment, and access to a central model registry. The trained auto-ARIMA model can generate predictions for multiple horizons or payroll periods, such as two-cycle, three-cycle, or longer forecast ranges. Feedback obtained from user interactions, anomaly classification results, or automated processes can be incorporated to refine and improve model performance over time.

The model 116 can implement conformal prediction intervals to generate or determine upper and lower bounds in addition to point forecasts, thereby quantifying uncertainty in predicted wage amounts and facilitating the estimation of a permissible value range rather than a single point prediction. Actual values that fall outside the prediction intervals can be flagged for anomaly detection, with significant deviations above or below the bounds (e.g., gross pay much higher or lower than expected) classified as anomalies.

The model 116 can extract and use variations in the time series data as features, including seasonality patterns that repeat over periods. Seasonality can be detected, for example, in yearly performance cycles that result in recurring spikes in payroll constructs such as bonuses or allowances. Seasonality parameters can be incorporated during training, with a monthly payroll configured for a seasonality length of twelve intervals, and a biweekly payroll set for twenty-six intervals to indicate a fourteen-day cycle. Model performance and predictive accuracy can be evaluated via a model manager 142 using metrics such as mean absolute error (MAE) and root mean squared error (RMSE), such that forecasts remain computationally accurate and contextually relevant across payroll frequencies and operational domains.

The database 110 can include, maintain, or otherwise store bounds 118. The bounds 118 can refer to any limits, thresholds, ranges, or constraint values associated with one or more predicted or actual data values for a corresponding object identifier, such as an employee, payroll batch, client account, device, or other monitored entity. The bounds 118 can be determined or generated through statistical techniques, rule-based logic, or models 116. The bounds 118 can specify upper limits, lower limits, confidence intervals, prediction intervals, or acceptable variation margins for a given data element. For example, in payroll processing contexts, the bounds 118 can define the acceptable upper and lower pay amounts for a particular wage type or category, taking into account historical payroll data, seasonality, bonuses, deductions, client-specified tolerances, or country-specific compliance requirements. The bounds 118 can be determined or computed using techniques such as conformal prediction, cross-validation across historical datasets, standard deviation calculations, percentile thresholds, or other statistical or algorithmic processes. The bounds 118 can be adjusted for seasonal tolerance ranges to specify predictable cyclical patterns (e.g., annual performance bonuses, quarterly adjustments). The bounds 118 can be dynamically updated based on recent transactions, variance validations, user feedback, or automated retraining of predictive models.

The database 110 can include, maintain, or otherwise store rules 120. The rules 120 can refer to any logical expressions, policies, conditions, constraints, procedures, or other directives that govern how data is validated, processed, or acted upon within the data processing system 102. The rules 120 can be applied to evaluate incoming or historical data associated with an object identifier such as an employee, payroll batch, client account, device, or other monitored entity. The rules 120 can be static, schedule-driven, or dynamically updated and can be formulated using domain-specific parameters, jurisdiction-specific regulatory mandates, industry standards, contractual constraints, seasonal adjustment logic, or operational workflows. For example, in payroll processing contexts, the rules 120 can define allowable thresholds for wage type variations, eligibility criteria for benefits such as healthcare contributions or car allowances, computation steps for tax deductions, country-specific compliance validations, adjustments for periodic bonuses, or overrides based on client-specified tolerances. The rules 120 can operate independently or in conjunction with the models 116 to determine whether a detected variance is to be classified as relevant, severe, anomalous, or acceptable, and can integrate with outputs from components such as a variance determiner 134 and an anomaly detector 136. The rules 120 can be updated dynamically based on variance validations, anomaly severity or relevance scoring, and user feedback detected via application user interface 144. The rules 120 can include mechanisms for controlling or influencing data processing operations, including specification syntax definitions, execution and evaluation techniques, centralized or distributed storage formats, and mappings to application-specific and cross-domain schemas.

The data processing system 102 can include, interface with, communicate with, or otherwise utilize a system processor 122. The system processor 122 can execute one or more instructions associated with the data processing system 102. The system processor 122 can include an electronic processor, an integrated circuit, or the like, including one or more of digital logic, analog logic, digital sensors, analog sensors, communication buses, volatile memory, nonvolatile memory, and the like. The system processor 122 can include, but is not limited to, at least one central processing unit (CPU), graphics processing unit (GPU), physics processing unit (PPU), tensor processing unit (TPU), embedded controller (EC), or the like. The system processor 122 can include a memory operable to store or storing one or more instructions for operating components of the system processor 122 and operating components operably coupled to the system processor 122. For example, the one or more instructions can include one or more of firmware, software, hardware, operating systems, or embedded operating systems. The system processor 122 or the data processing system 102 can include one or more communication bus controllers to effect communication between the system processor 122 and the other elements of the data processing system 102.

The data processing system 102 can include, interface with, communicate with, or otherwise utilize an interface controller 124. The interface controller 124 can be or include any script, file, program, application, set of instructions, or computer-executable code that can be configured to facilitate communication among the data processing system 102, the client system 104, and the system of record 106. The interface controller 124 can include hardware, software, or any combination. The interface controller 124 can facilitate communication among the data processing system 102, the client system 104, and the system of record 106 via one or more communication interfaces. A communication interface can include, for example, an application programming interface (“API”) compatible with a particular component of the data processing system 102, the client system 104, or the system of record 106. The communication interface can provide a particular communication protocol compatible with a particular component of the data processing system 102, a particular component of the client system 104, or a particular component of the system of record 106. The interface controller 124 can be compatible with particular content objects and can be compatible with particular content delivery systems corresponding to particular content objects, structures of data, types of data, or any combination thereof. For example, the interface controller 124 can be compatible with the transmission of structured or unstructured data according to one or more metrics.

The data processing system 102 can include, interface with, communicate with, or otherwise utilize an operation controller 126. The operation controller 126 can be or include any script, file, program, application, set of instructions, or computer-executable code that can be configured to manage and execute actions associated with one or more components of the data processing system 102, the client system 104, or the system of record 106. The operation controller 126 can define and manage workflows comprised of multiple interconnected tasks. The operation controller 126 can initiate, monitor, and control the execution of workflow steps. The operation controller 126 can implement conditional logic for dynamic workflow routing. The operation controller 126 can execute multiple tasks concurrently through parallel processing. The operation controller 126 can implement error handling and recovery mechanisms for workflow exceptions. The operation controller 126 can track workflow progress and provide status updates. For example, the operation controller 126 can include one or more interfaces to detect input at various portions of a workflow and can provide output responsive to specific portions of a workflow.

The data processing system 102 can include, interface with, communicate with, or otherwise utilize a data collector 128. The data collector 128 can be or include any script, file, program, application, set of instructions, or computer-executable code that can be configured to operate in conjunction with one or more processing components to collect data from one or more systems of record 106 associated with historical network operations. The data collector 128 can obtain data from multiple sources, repositories, databases, client-specific data feeds, or a federated data platform implemented on a scalable cloud-based architecture. The data collector 128 can retrieve, stream, query, or otherwise acquire data related to historical network operations for a corresponding object identifier, such as an identifier for an object, employee, device, account, payroll batch, or other monitored entity. Operational data from multiple sources, including personnel records, foundational system data, human resources datasets, and financial transaction data, can be ingested into the data collector 128.

The historical network operations can include transaction operations, including payroll operations or multi-country payroll processing. In such instances, the data collector 128 can collect payroll records including, for example, transaction values, compensation details, time-off balances, benefits information, performance reviews or metrics, termination records, or tax records. The transactional data, or payroll data, can include attributes such as a client identifier, country, employee identifier, pay frequency, pay start date, pay end date, wage type identifier, wage type category, wage amount, seasonal bonus indicators, and compliance-specific fields, among others. The collected payroll data can be used to predict or validate wage types such as gross pay, net pay, earnings, deductions, or other compensation-related amounts. The payroll-specific implementation is provided by way of example only, and references to historical network operations herein are intended to include other operational domains in addition to payroll processing.

The data collector 128 can normalize, pre-process, clean, transform, or otherwise improve the quality, completeness, and consistency of the collected data before the data is used for processing, including, but not limited to, training a model 116, validating predicted outputs, performing anomaly detection, or generating reports. The pre-processing can include filtering invalid records, reconciling data from multiple sources, managing missing values, correcting data formats, removing duplicates, applying domain-specific rules, or enriching the data with contextual attributes. The data collector 128 can be configured to process structured, semi-structured, and unstructured data formats, including but not limited to database tables, spreadsheets, log files, JSON or XML documents, PDF files, or raw legislative text.

The data collector 128 can incorporate security and compliance features such as encryption of data in transit and at rest, anonymization or pseudonymization of object identifiers, and jurisdiction-specific filtering to comply with applicable regional and multi-jurisdictional data protection requirements. The data collector 128 can operate in real-time or near-real-time, or according to scheduled intervals, and can be triggered by specific events such as completion of a payroll batch, detection of a variance, receipt of new records from the system of record 106, or initiation of a validation workflow. The data collector 128 can operate across distributed computing environments and receive data from multiple federated systems of record 106 via direct database connections, APIs, data integration tools, streaming pipelines, or other suitable communication protocols. The data collector 128 can implement custom or predefined extraction procedures, process historical and ongoing data loads, apply seasonal data segmentation for forecasting accuracy, and persist data into relational or object stores for downstream predictive modeling, variance determination, or anomaly detection.

The data processing system 102 can include, interface with, communicate with, or otherwise utilize a predictor 130. The predictor 130 can be or include any script, file, program, application, set of instructions, or computer-executable code that can be configured to generate predicted values for one or more parameters related to a network operation associated with an object identifier at a specified time interval. The predictor 130 can operate using one or more models 116 trained with machine learning techniques on data, historical data, or operational logs collected from one or more systems of record 106 associated with historical network operations. The predictor 130 can generate predicted values using time series forecasting on structured, semi-structured, or unstructured datasets, including statistical modeling techniques such as moving averages, autoregressive integrated moving average (ARIMA) models, or auto-ARIMA models implemented via the StatsForecast framework that provides statistical and econometric models for forecasting time series data.

The predictor 130 can generate a plurality of predicted values using the models 116 configured with conformal prediction, conformal prediction intervals, or seasonality adjustments to provide valid prediction intervals, including determination of upper and lower bounds for predicted values based on the conformal prediction. Such bounds can be used to identify or classify variances when actual operational values fall outside the predicted range. The predictor 130 can generate the plurality of predicted values using the one or more models 116 configured with cross-validation across the data or historical data sequences associated with historical network operations to maintain accuracy and robustness.

In the context of payroll processing, the predictor 130 can generate predicted wage amounts or other payroll parameters for a given object identifier, such as an employee profile or payroll batch, at a first time interval corresponding to a payroll cycle. In such instances, the underlying model 116 can be trained on data collected from one or more systems of record 106 associated with historical payroll operations, including fields such as client identifier, country, pay frequency, pay start date, pay end date, wage type identifier, wage type category, gross pay, net pay, deductions, allowances, and seasonal bonus data over multiple prior pay periods. The predictor 130 can implement conformal prediction techniques to generate upper and lower bounds for expected payroll values and can execute cross-validation using portions or subsets of the historical payroll dataset to refine model performance and account for seasonality factors such as yearly performance cycles, biweekly pay intervals, or other recurring payroll patterns.

The data processing system 102 can include, interface with, communicate with, or otherwise utilize an outcome identifier 132. The outcome identifier 132 can be or include any script, file, program, application, set of instructions, or computer-executable code that can be configured to operate with one or more processing components to identify, from one or more systems of record 106, a plurality of actual values output responsive to execution of a network operation at a first, specific, or scheduled time interval. The outcome identifier 132 can process structured, semi-structured, or unstructured datasets retrieved from operational logs, transaction records, event measurements, or other forms of output data corresponding to the object identifier. The structured, semi-structured, or unstructured datasets can include multi-country payroll data, client-specific transaction records, operational logs, event measurements, HR data, foundation data, or other forms of output data corresponding to the object identifier. The outcome identifier 132 can parse and validate output records, associate values with particular parameters or metrics, normalize output formats to a standardized schema across regions, and store the identified actual values for subsequent variance detection, anomaly evaluation, or machine learning model retraining.

In the context of payroll processing, the outcome identifier 132 can acquire actual payroll values for one or more wage types and related parameters from the system of record 106 responsive to execution of a payroll operation for a given employee profile or payroll batch. Such values can include client identifier, country code, pay frequency, pay start date, pay end date, wage type identifier, wage type category, gross pay, net pay, deductions, bonuses, seasonal or performance-based allowances, benefits contributions, or other compensation-related amounts for the completed pay period. The identified values can be correlated and aligned with corresponding predicted values generated by the predictor 130 to support variance determination, relevancy evaluation, and seasonality-aware anomaly detection.

The data processing system 102 can include, interface with, communicate with, or otherwise utilize a variance determiner 134. The variance determiner 134 can be or include any script, file, program, application, set of instructions, or computer-executable code that can be configured to operate with one or more processing components to determine a variance in at least one value of a plurality of actual values based on a comparison between the actual values identified by the outcome identifier 132 and the predicted values generated by the predictor 130. The variance determiner 134 can determine or evaluate whether at least one actual value falls outside predetermined limits, dynamic thresholds, or seasonal tolerance ranges, such as an upper bound and a lower bound, determined by the predictor 130 using techniques such as conformal prediction, seasonality-aware bound computation, or other statistical or machine learning techniques. The variance determiner 134 can quantify the variance as a numerical deviation, percentage difference, ratio, or other metric, and can store or provide the determined variance for subsequent relevancy evaluation, anomaly detection, or model retraining.

In the context of payroll processing, the variance determiner 134 can compare predicted payroll amounts for a given employee profile or payroll batch against actual payroll values for client identifier, country code, pay frequency, pay start date, pay end date, wage type identifier, wage type category, gross pay, net pay, deductions, allowances, bonuses, or seasonal or performance-based compensation adjustments. Suppose an actual value falls outside the determined upper or lower bound for the corresponding wage type. In such instances, the variance determiner 134 can flag the deviation and associate the deviation with relevant contextual data, including multi-country rule configurations, historical variance patterns, anomaly severity scores, and relevance indicators, to facilitate downstream processing such as determining variance severity, determining variance relevance, or initiating a review workflow.

The data processing system 102 can include, interface with, communicate with, or otherwise utilize an anomaly detector 136. The anomaly detector 136 can be or include any script, file, program, application, set of instructions, or computer-executable code that can be configured to operate with one or more processing components to detect, using the one or more models 116, an anomaly in a variance determined by a variance determiner 134. The anomaly detector 136 can implement machine learning-based classification, context-aware statistical techniques, or seasonality-adjusted anomaly scoring to detect whether a given variance corresponds to an anomalous deviation that triggers additional processing. The anomaly detector 136 can determine, using the one or more models 116, a severity of the variance, such as magnitude of deviation relative to dynamic or seasonal bounds, and a relevance of the variance, such as contextual importance based on object identifier attributes (e.g., client identifier, country code, pay frequency, wage type category), historical patterns, or applicable multi-country payroll rules. The anomaly detector 136 can detect anomalies, using the one or more models 116, based on the severity of the variance, the relevance of the variance, or a combination of the severity and relevance parameters.

The anomaly detector 136 can trigger, based on a load balancing technique, initiation of an anomaly detection process for a network operation at a given time interval, such that computational workload can be efficiently distributed across available resources. The data processing system 102 can trigger the anomaly detector 136 for a payroll operation at a first time interval based on frequency (e.g., monthly, biweekly), load level, capacity, seasonality cycle, or other operational criteria to improve computational efficiency and avoid unnecessary resource utilization. Upon being triggered, the anomaly detector 136 can execute the anomaly detection process to detect anomalies in variances for the associated network operation.

The anomaly detector 136 can detect anomalies in variances based on an audit log by evaluating audit logs corresponding to the object identifier, such as logs of modifications, transactions, or configuration changes, and comparing such logs to predicted and actual operational values to identify inconsistencies or unlogged deviations. For example, suppose a configuration or setting is modified according to an audit log, but the corresponding actual value remains unchanged, resulting in a condition where a variance is expected but absent, which the anomaly detector 136 can detect as an anomaly.

In the context of payroll processing, the anomaly detector 136 can use machine learning models 116 trained on historical payroll data to determine whether variances in wage types, client identifier, country code, pay frequency, gross pay, net pay, deductions, allowances, bonuses, benefits contributions, or other payroll parameters for a profile 114 or payroll batch are anomalous. In such instances, severity can specify the size of the deviation relative to upper and lower bounds (e.g., gross pay exceeding an upper prediction limit), while relevance can specify the operational impact (e.g., variance in a regulatory compliance field, country-specific tax deduction, or benefit contribution that impacts payroll reporting for a full-time employee). Such detections can include real-time or scheduled processing triggered after payroll batch completion, and can include automated assessment of audit logs for changes in payroll inputs or approvals.

The data processing system 102 can include, interface with, communicate with, or otherwise utilize an action controller 138. The action controller 138 can be or include any script, file, program, application, set of instructions, or computer-executable code that can be configured to operate with one or more processing components to execute, responsive to detection of an anomaly by the anomaly detector 136, one or more actions based on the anomaly. The action controller 138 can initiate an update of the one or more models 116 based on characteristics of the anomaly, such as variance magnitude, relevance, recurrence, or classification outcome. The action controller 138 can execute an action, including providing, for display via a graphical user interface, an indication of the detected anomaly with contextual data such as predicted values, actual values, variance metrics, severity scores, and relevance scores, among others. The actions performed by the action controller 138 can include correcting an error, blocking an operation, executing an operation, or providing a notification, and can further include automated responses such as adjusting threshold values, modifying rules, triggering validation processes, initiating alerts, or updating historical datasets to indicate the anomaly classification. In the context of payroll processing, the action controller 138 can present anomalies in payroll amounts, deductions, or benefits contributions for an employee or payroll batch, initiate practitioner review or approval through a payroll validation interface, and record the outcome for use in retraining predictive models of payroll operations.

The data processing system 102 can include, interface with, communicate with, or otherwise utilize a feedback generator 140. The feedback generator 140 can be or include any script, file, program, application, set of instructions, or computer-executable code that can be configured to operate with one or more processing components to receive, responsive to an interaction with a graphical user interface (GUI) presented via an application user interface 144, and process user feedback related to anomalies detected in variances. The feedback generator 140 can receive or detect an indication to invalidate the anomaly, where invalidating the anomaly validates the corresponding variance, or an indication to validate an anomaly, where validating the anomaly invalidates the corresponding variance. Such indications can be detected through interactive workflows in which a user via the client device 104 or the application user interface 144 reviews a displayed anomaly indication and classifies the anomaly indication, for example, as valid, invalid, or acceptable according to operational context.

The feedback generator 140 can receive, from the client device 104 rendering the GUI or the application user interface 144, free-form natural language text input or structured data entries specifying a classification outcome or explanatory annotation associated with the user's determination. The feedback generator 140 can receive such interactions, including natural language text input, and process the received data for association with corresponding anomaly or variance records. The feedback generator 140 can encode the received input with associated metadata, such as object identifier, predicted values, actual values, variance metrics, severity scores, relevance scores, and timestamp, in a standardized data structure for use in machine learning model retraining. The feedback package can then be stored in the database 110 or transmitted to a model manager 142 for use in retraining the one or more models 116 to adapt prediction and anomaly detection parameters based on user review. In the context of payroll processing, the feedback generator 140 can receive practitioner-provided annotations indicating variance classifications or adjustment reasons (e.g., bonus applied, healthcare deduction adjusted, tax correction, or pay element absent where an audit log records a payroll input or configuration change but the corresponding actual output does not reflect the change), detect the annotations with associated structured parameters (e.g., wage type, pay period), and format the combined data into a standardized feedback dataset for incorporation into subsequent training cycles of payroll prediction models.

The data processing system 102 can include, interface with, communicate with, or otherwise utilize a model manager 142. The model manager 142 can include hardware, software, or any combination thereof. The model manager 142 can train, fine-tune, update, re-train, deploy, or otherwise maintain one or more models 116 (also referred to herein as a model 116). The model 116 can be a machine learning model 116. The model manager 142 can manage and coordinate the training, fine-tuning, and updating of the models 116. The model manager 142 can operate as a remote service that interacts with the data processing system 102, the client system 104, or the system of record 106 via the interface controller 124. The model manager 142 can facilitate training of one or more models 116 using machine learning techniques on training data collected from one or more systems of record(s) 106, operational logs, or other historical datasets, and associated outputs generated by the data processing system 102. The training data can include, but is not limited to, structured, semi-structured, or unstructured data corresponding to predictions, actual operational values, variance metrics, anomaly classifications, user feedback annotations, and contextual metadata, among others. The model manager 142 can implement supervised learning, unsupervised learning, semi-supervised learning, reinforcement learning, or combinations thereof, depending on the target prediction or anomaly detection objective.

The model manager 142 can continuously monitor the performance of deployed machine learning models 116, identify accuracy degradation, prediction drift, seasonal pattern misalignment, or error anomalies, and update the models 116 based on detected degradation, drift, or error patterns. The model manager 142 can use various machine learning algorithms, including supervised learning techniques, to train, fine-tune, or update the models 116 using labeled data or training datasets to improve multi-country prediction accuracy, classification capabilities, and variance relevance or severity determination. The model manager 142 can implement unsupervised learning techniques, such as clustering and association rule mining, to identify patterns in unlabeled data, for example, recurring payroll anomalies grouped by country code, client identifier, or wage type category, or to generate inferred labels for such data. The model manager 142 can implement reinforcement learning techniques to update the models 116 based on user-provided feedback or training datasets.

The model manager 142 can update the models 116 based on anomalies detected in variances between predicted and actual values, as identified by system components such as a variance determiner 134 and anomaly detector 136. In such instances, the updates can include retraining model parameters, adjusting feature sets, modifying threshold values, or changing rule interactions to improve accuracy and responsiveness. The model manager 142 can update the one or more models 116 based on the invalidation or validation of an anomaly to control performance of the one or more models 116 in detecting anomalies associated with subsequent network operations. For example, the model manager 142 can update the models 116 based on the invalidation of an anomaly, thereby validating the corresponding variance, to refine model behavior and reduce false positives in anomaly detection during subsequent network operations. Additionally, the model manager 142 can update models based on the validation of an anomaly, thereby invalidating the corresponding variance, to enhance detection sensitivity for similar patterns during subsequent network operations and across different payroll frequencies or compliance jurisdictions.

The model manager 142 can update the one or more models 116 based on the natural language text input or feedback packages, including anomaly context metadata. For example, the model manager 142 can receive natural language text input or structured annotations detected by a feedback generator 140, parse and encode the input into a standardized data format, including object identifier, client identifier, country code, pay period, wage type identifier, bounds exceeded, severity score, and related metadata, and use the resulting labeled data to retrain or fine-tune the models 116. The model manager 142 can manage multiple concurrent models 116, each with different architectures (e.g., ARIMA, auto-ARIMA, or transformer-based time series models) or domain scopes, and coordinate scheduled retraining, on-demand updates, or continuous learning loops to balance performance objectives with computational resources. In the context of payroll processing, the model manager 142 can train and update predictive models 116 for wage amounts, deductions, allowances, bonuses, benefits contributions, regulatory compliance fields, or other payroll parameters based on historical payroll data, detected anomalies in payroll processing, seasonality patterns for the applicable payroll frequency, and annotated feedback from payroll practitioners specifying variances or adjustment reasons.

The client system 104 can execute an application that communicates with the data processing system 102 and the system of record 106. The application can present one or more application user interfaces 144. The application user interface 144 can provide visual and interactive elements to facilitate user interaction or engagement. Users can input information, view content, or initiate actions through the application user interface 144. The application user interface 144 can be associated with a particular client application that communicates with the data processing system 102 or the system of record 106 to process user instructions. The client application can include an application executing on each client system 104, such as a web application, a server application, a resource, a desktop, or a file. The client application can include a local application (e.g., local to a client system), a hosted application, a software-as-a-service (SaaS) application, a virtual application, a mobile application, and other forms of content. The client application can include or correspond to applications provided by remote servers or third-party servers.

The client system 104 can include, interface with, communicate with, or otherwise utilize a client communicator 146. The client communicator 146 within the client system 104 can be similar to, and include any of the structure and functionality of, the interface controller 124 described in connection with the data processing system 102. For example, the client communicator 146 within the client system 104 can communicate with the data processing system 102 or the system of record 106 via the network 108 using one or more communication interfaces to carry out the various operations described herein. The client communicator 146 can be compatible with particular content delivery systems corresponding to particular content objects, structures of data, types of data, or any combination thereof.

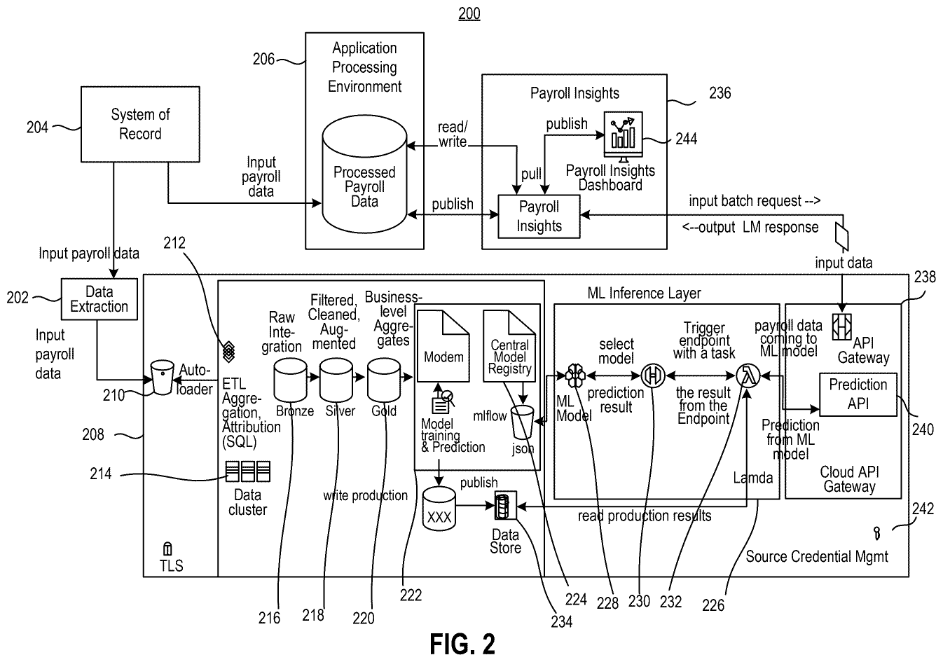

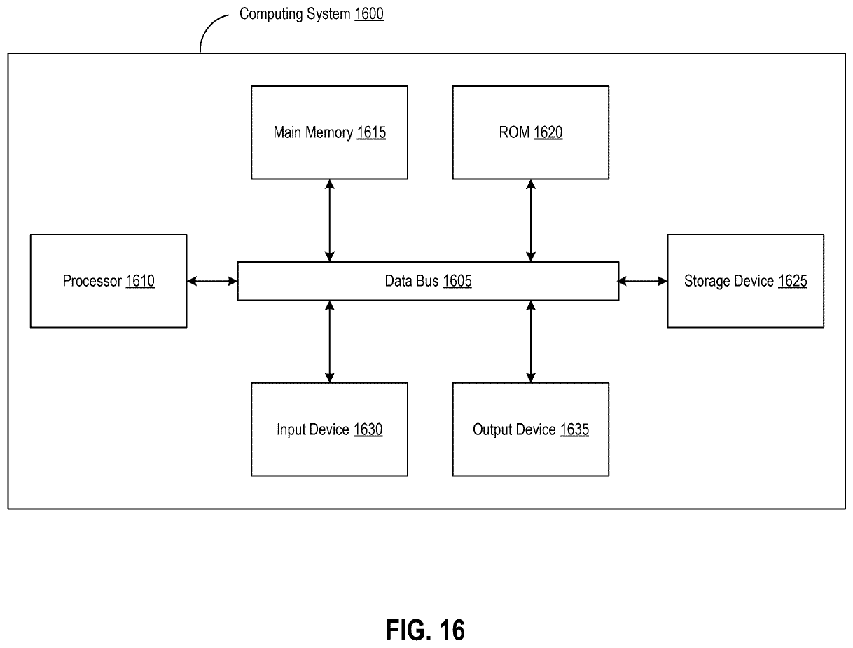

FIG. 2 depicts an example machine learning (ML) architecture 200 for anomaly detection in cross-system operations, in accordance with some implementations. The ML architecture 200 of FIG. 2 can include one or more systems, components, or functionalities depicted in FIG. 1 or FIG. 16. As shown in FIG. 2, the ML architecture 200 can include one or more data extraction, transformation, and inference components configured to facilitate anomaly detection in cross-system operations. A data extraction component 202 can receive or extract payroll data from one or more upstream systems, including a system of record 204 that provides data associated with payroll processing. An application processing environment 206 can be implemented to securely manage, process, and distribute payroll data. The application processing environment 206 can authenticate and authorize access to incoming data streams, extract payroll data from the authenticated stream, and perform computations to generate processed payroll data or outputs. The application processing environment 206 can maintain computed outcomes in a secure state for integrity preservation and controlled release. The data extraction component 202 can provide the payroll data extracted from the system of record 204 to an autoloader 208, which can store files in a JSON repository 210. The autoloader 208 can provide the stored files to ETL (e.g., extract, transform, load) aggregation and attribution layer 212, which can execute SQL-based transformation, aggregation, and attribution operations across a distributed data cluster 214.

The ETL aggregation and attribution layer 212 can write successive integration stages into layered data storage structures, including a bronze layer 216 for raw integration, a silver layer 218 for filtered and cleaned data, and a gold layer 220 for business-level augmented aggregates. Each layer can provide structured datasets for model training and inference. A model training and prediction component 222 can access the layered datasets, execute model training, and provide trained model artifacts to a central model registry 224 maintained via ML flow integration.

Model configurations and metadata from the central model registry 224 can be accessed in JSON format by an ML inference layer 226. The ML inference layer 226 can include a model selection component 228 configured to select one or more models from the central model registry 224 for a given payroll task. The model selection component 228 can communicate with a model endpoint 230, which can perform inference or prediction operations. A trigger endpoint 232 can initiate the inference operation in response to a received batch request or load-balancing signal. The trigger endpoint 232 can execute endpoint orchestration and ingest results returned from the model endpoint 230. The trigger endpoint 232 can provide the inference output to a data store 234 for storage, retrieval, or further processing. The data store 234 can provide the inferred results for downstream reporting and visualization via a payroll insights component 236. The ML inference layer 226 can interact with a prediction API 240 exposed via a cloud API gateway 238. The prediction API 240 can function as an access interface to the inference outputs generated by the ML inference layer 226 for the client devices 104.

The ML architecture 200 can include a source credential manager 242 configured to manage authentication, encryption, and secure channel establishment for communications across the ML architecture 200, including transport layer security (TLS) protection. At the application level, the payroll insights component 236 can provide data to a payroll insights dashboard 244, which can present analytical summaries, predicted anomalies, and payroll operation metrics to the client devices 104. The payroll insights component 236 can receive data from the application processing environment 206, maintain outputs, and support read or write operations for insights publication and visualization.

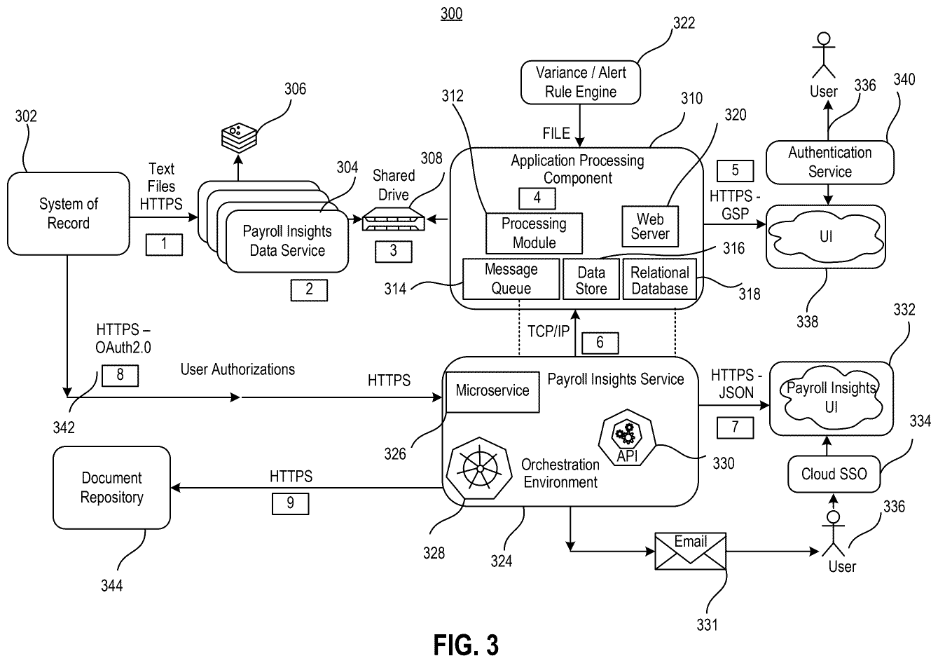

FIG. 3 depicts an example operational system architecture 300 for anomaly detection in cross-system operations, in accordance with implementations. The operational architecture of FIG. 3 can include one or more systems, components, or functionalities depicted in FIG. 1 or FIG. 16. As shown in FIG. 3, the operational architecture 300 for anomaly detection in cross-system operations can include one or more data-service, middleware, and user-interface layers. A payroll insights data service 304 can receive payroll-related data from a system of record 302 transmitted as text files via a secure HTTPS channel. The payroll insights data service 304 can execute data ingestion, preprocessing, and staging for downstream components. The payroll insights data service 304 can store intermediate and processed computation outputs in a cache component 306. The operational architecture 300 can include an authorization channel through which the payroll insights data service 304 or a payroll insights service 324 can verify user credentials or obtain access tokens from the system of record 302 via an authentication endpoint 342 using an OAuth 2.0 protocol. The payroll insights data service 304 can provide processed data to a shared drive 308, which can function as an access point for other connected systems and facilitate retrieval of the data. For example, an application processing component 310 can retrieve input data from the shared drive 308 for centralized application processing and integration. The application processing component 310 can include a processing module 312, a message queue 314, a data store 316, a relational database 318, and an application server executed via a web server 320. The application processing component 310 can receive configuration or rule data from a variance or alert rule engine 322, which can generate rule files defining anomaly-detection thresholds or trigger conditions.

The application processing component 310 can exchange data with the payroll insights service 324 over a TCP or IP connection. The payroll insights service 324 can be implemented as a microservice 326 and deployed in a containerized orchestration environment 328 to facilitate scaling, load management, and orchestration of microservices. The payroll insights service 324 can expose one or more API interfaces 330 for communication with external components and can transmit processed data or alerts as email notifications 331. The payroll insights service 324 can interface via a secure HTTPS channel with a document repository 344 or a customer relationship management (CRM) system, which can provide supporting documents or data associated with payroll operations.

The payroll insights service 324 can further communicate via HTTPS-JSON interfaces with a payroll insights user interface 332, which can render analytic results, detected anomalies, or system alerts. The payroll insights user interface 332 can authenticate access through a cloud-based single sign-on component 334, which can facilitate secure login for authorized users 336. The application processing component 310 can also interface via HTTPS-GSP with a user interface 338, which can be accessed by the authorized users 336 via a cloud-based authentication service 340. The operational architecture 300 can facilitate continuous ingestion of payroll data, evaluation of deviations or anomalies using predictive models, generation of alerts, and visualization of outputs across multiple heterogeneous payroll systems.

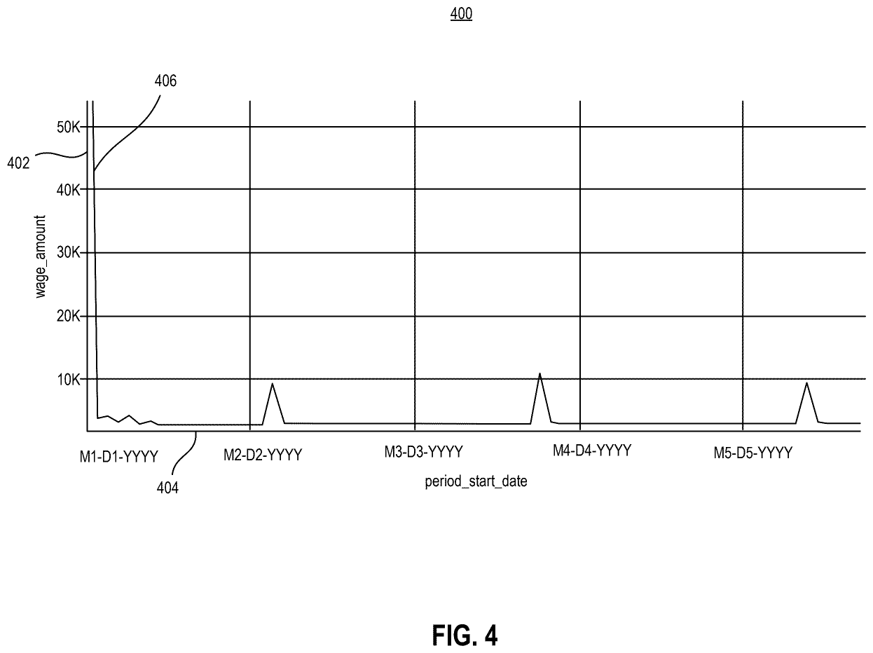

FIG. 4 depicts an example graph 400 illustrating variations in wage amount over time for an identified entity, in accordance with some implementations. The graph 400 can present wage amounts 402 along the y-axis relative to period start dates 404 along the x-axis. The graph 400 can present a plotted line 406 indicating a sequence of payroll records retrieved from the one or more systems of record(s) for the corresponding entity. The graph 400 can present one or more spikes and low-value intervals, where each spike can correspond to an anomaly detected by the system, as described in connection with FIGS. 1-3. For example, the system can detect deviations or anomalies at distinct time points such as M2-D2-YYYY, M3-D3-YYYY, and M5-D5-YYYY.

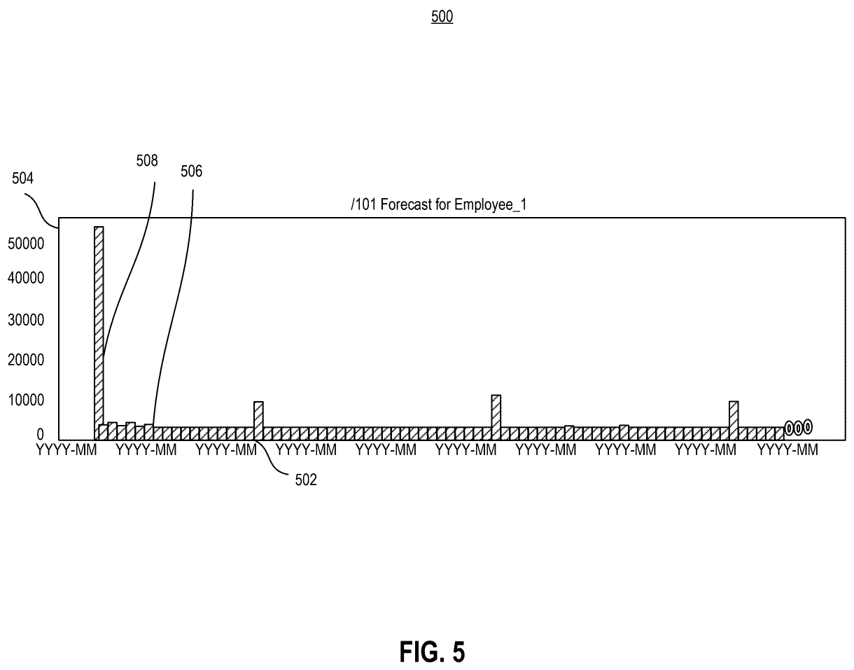

FIG. 5 depicts an example bar graph 500 illustrating a forecast of payroll values for an object identifier (e.g., Employee_1), in accordance with some implementations. The bar graph 500 can present a horizontal axis 502 indicating a sequence of period start dates and a vertical axis 504 indicating a wage amount associated with each payroll period. The bar graph 500 can present a series of forecast bars 506, which can indicate predicted wage values generated by the one or more models, as described in connection with FIGS. 1-3. Each forecast bar 506 can correspond to a wage prediction output for a respective time interval. Each forecast bar 506 can correspond to a specific wage type, such as wage type 101, or another categorized pay element associated with the employee identifier. The bar graph 500 can present one or more spike bars 508 indicating predicted anomalies where the wage amount deviates from a historical baseline or exceeds an expected range determined using conformal prediction intervals. In FIG. 5, the repeated occurrence of spike bars 508 at distinct time intervals can illustrate anomalous patterns detected for Employee_1 across multiple pay cycles.

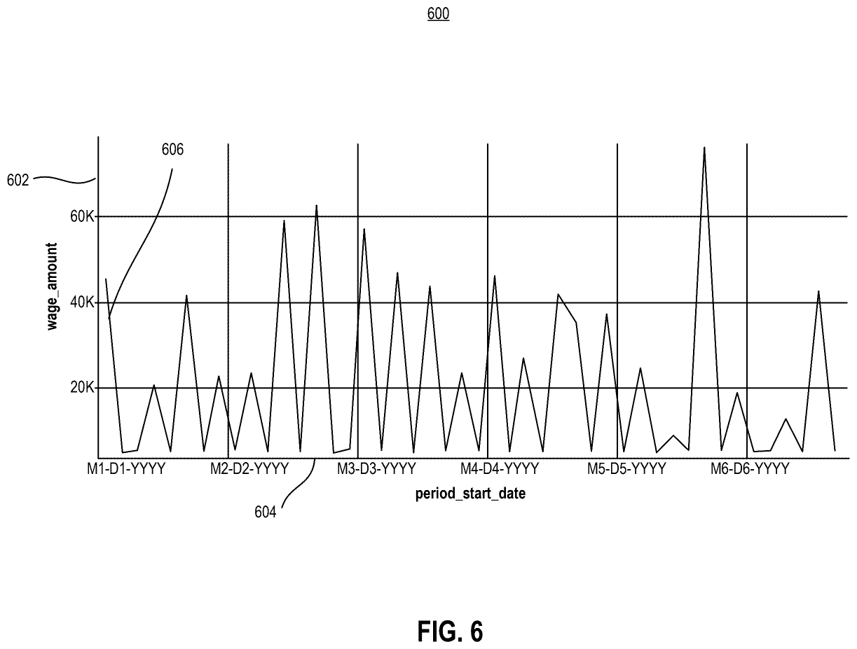

FIG. 6 depicts an example graph 600 illustrating wage variations for an entity across multiple time intervals, in accordance with some implementations. The graph 600 can present wage amounts 602 along the y-axis relative to period start dates 604 along the x-axis. The graph 600 can present a plotted line 606 indicating recorded wage values over time. The plotted line 606 can present recurring peaks that indicate cyclical payroll fluctuations. For example, certain high-amplitude peaks can indicate detected anomalies corresponding to unusually elevated wage amounts relative to adjacent time periods.

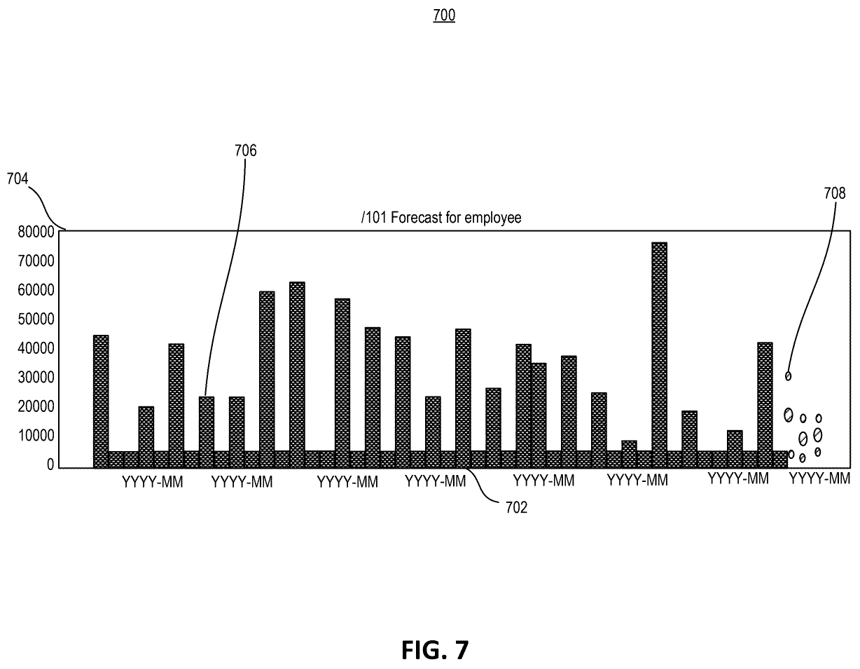

FIG. 7 depicts an example bar graph 700 illustrating a payroll forecast for an employee identifier, in accordance with some implementations. The graph 700 can present a horizontal axis 702 indicating payroll periods and a vertical axis 704 indicating wage amounts. The graph 700 can present a series of forecast bars 706, which can indicate predicted wage values across the periods. Each forecast bar 706 can correspond to a specific wage type, such as wage type 101, or another categorized pay element associated with the employee identifier. The graph 700 can also present one or more outlier points 708, indicating forecasted anomalies or irregular wage spikes detected by the one or more models for a corresponding employee identifier, as described in connection with FIGS. 1-3.

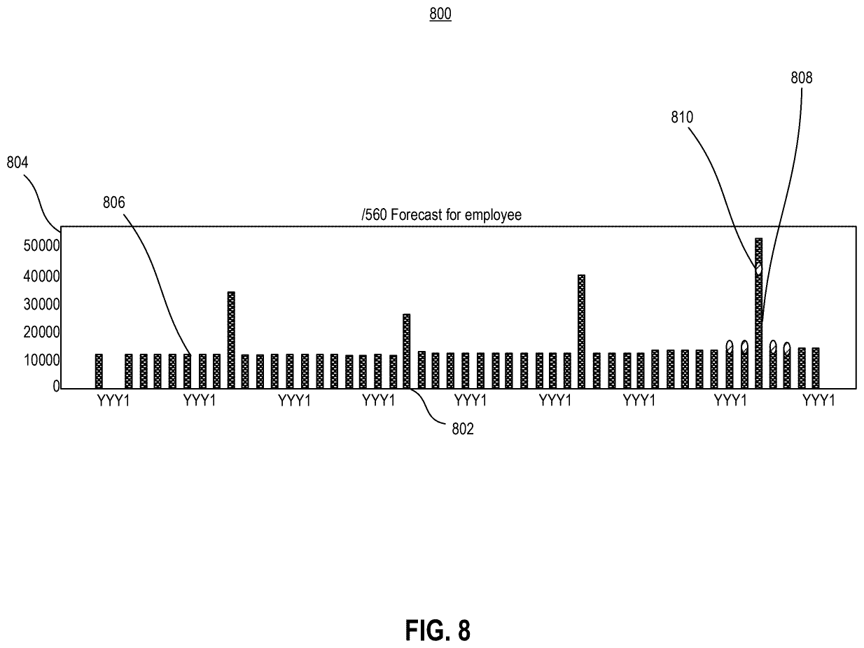

FIG. 8 depicts an example bar graph 800 illustrating a payroll forecast for an employee identifier, in accordance with some implementations. The graph 800 can present a horizontal axis 802 indicating payroll periods and a vertical axis 804 indicating wage amounts. The graph 800 can present a series of forecast bars 806, which can indicate predicted payroll values, and a subset of elevated bars 808, which can indicate predicted anomalies where wage amounts exceed expected or typical ranges. The forecast can be generated for a single employee's historical payroll data, without clustering across other employees or companies, to comply with privacy requirements and improve predictive accuracy. Each forecast bar 806 can correspond to a specific wage type, such as wage type 560, or another categorized pay element associated with the employee identifier. The graph 800 can also present a group of outlier points 810 adjacent to the elevated bars 808 that specify uncertainty intervals or confidence deviations associated with the predicted payroll values generated by the one or more models, as described in connection with FIGS. 1-3. Such forecasts can take into account the configured execution frequency for payroll prediction processes (e.g., monthly) to optimize computational efficiency. Forecast accuracy can correspond to the pay or operation frequency and the volume of historical records available for the given employee profile, with prediction intervals adapting automatically based on the employee's historical data and configured runtime parameters.

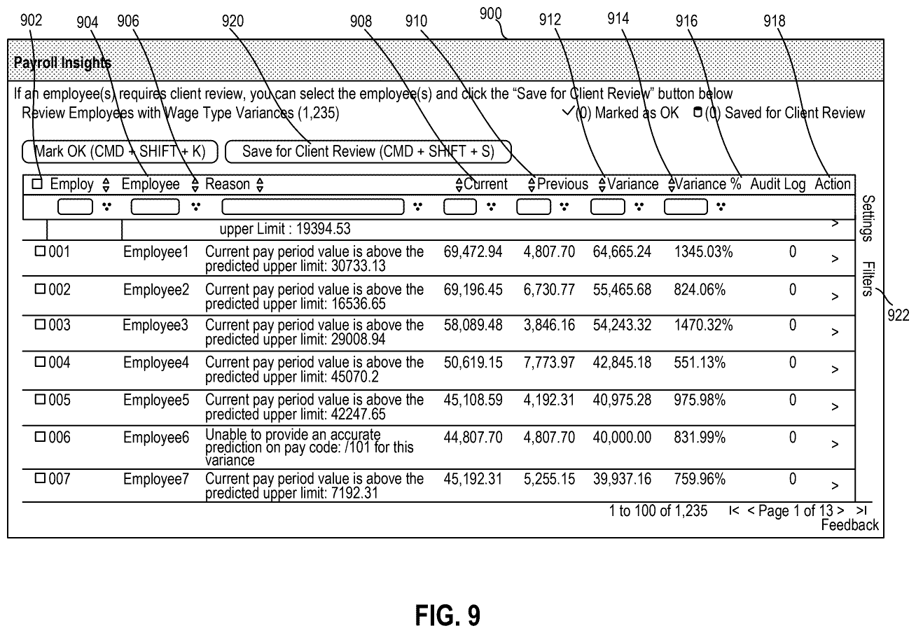

FIG. 9 depicts an example graphical user interface 900 illustrating a payroll variance dashboard for employees associated with a specific wage type, in accordance with some implementations. The graphical user interface 900 can present variance details for each employee payroll record, including an employee identifier field 902 (or a client identifier depending on the implementation), an employee name field 904, a reason field 906, a current amount field 908, a previous amount field 910, a variance amount field 912, a variance percentage field 914, an audit log field 916, and an action field 918. Each row in the graphical user interface 900 can correspond to a respective employee identifier for which a variance condition has been detected by the system, as described in connection with FIGS. 1-3. For example, as shown, the graphical user interface 900 can present instances where the current pay-period value exceeds a predicted upper limit (e.g., 19394.53) or falls outside the predicted range generated by the model. The variance percentage field 914 can indicate the degree to which the actual value deviates from the predicted range. The graphical user interface 900 can also present interactive control buttons 920, such as a client review button, to validate or flag the detected variances for subsequent analysis or client review. The graphical user interface 900 can present filter controls 922 to sort or filter payroll records based on variance range, wage type, or review status.

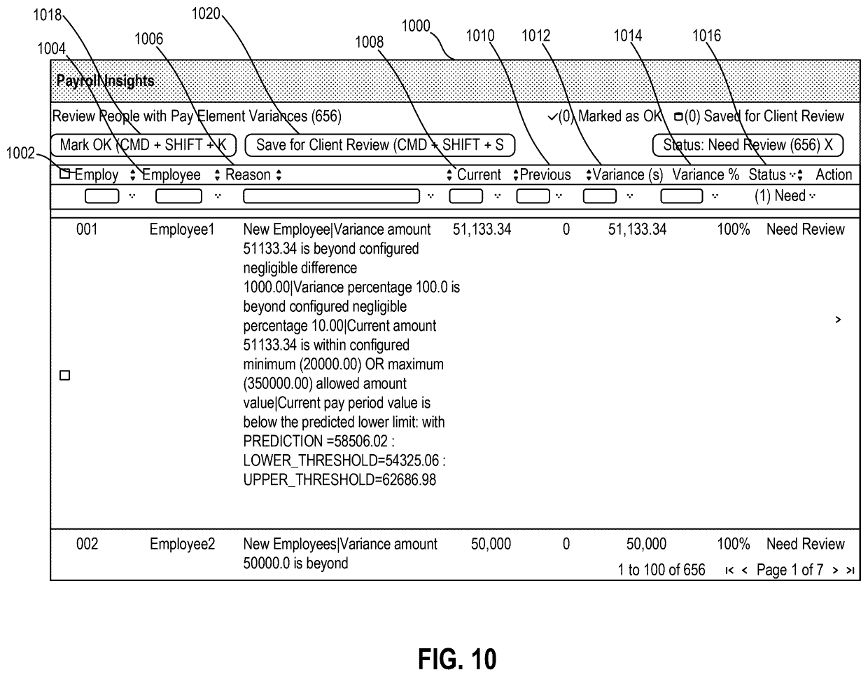

FIG. 10 depicts an example graphical user interface 1000 illustrating a payroll insights dashboard for reviewing pay element variances, in accordance with some implementations. The graphical user interface 1000 can present detected anomalies associated with payroll records. The graphical user interface 1000 can present each payroll record with one or more data fields, such as an employee identifier field 1002 (or a client identifier depending on the implementation), an employee name field 1004, a reason field 1006, a current amount field 1008, a previous amount field 1010, a variance amount field 1012, a variance percentage field 1014, and a review status field 1016. The graphical user interface 1000 can further present one or more interactive control buttons, such as a mark OK button 1018 and save for client review 1020, allowing a client device to classify or forward payroll variances for additional evaluation. The graphical user interface 1000 can present variance explanations relative to predicted values generated by the one or more models, as described in connection with FIGS. 1-3. For example, the graphical user interface 1000 can indicate when a variance amount exceeds configured thresholds or when the current value is below a predicted lower limit determined by the model. Such indications can be presented in the reason field 1006 via the determined prediction and corresponding lower and upper threshold values. The graphical user interface 1000 can facilitate an operator-assisted validation process by displaying anomaly outputs, associated threshold values, and actionable review tasks for each entity flagged for attention.

The graphical user interface 1000 can be configured to collect a user or a payroll practitioner input during the review process and package that feedback together with any contextual information presented or selected within the graphical user interface 1000. The packaged data can be transmitted to the system, which can process the feedback and incorporate the feedback into one or more models to improve prediction accuracy, variance classification, and anomaly detection performance. For example, a payroll practitioner can select “mark as OK” via the mark OK button 1018 and enter free-form or structured comments explaining why the variance is acceptable. The system can record the action, associate the action with the relevant payroll record, and transform the practitioner's comments and contextual data into a standardized format for training or fine-tuning the one or more models. Over time, patterns in variances frequently marked as OK can be learned by the models to reduce false positives and increase detection relevancy for future payroll runs.

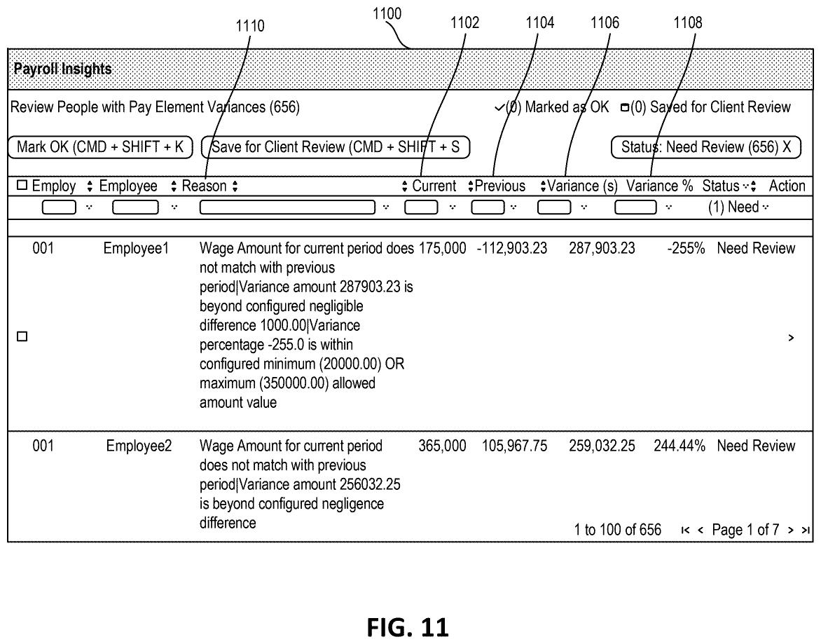

FIG. 11 depicts an example graphical user interface 1100 illustrating another view of the payroll insights dashboard, in accordance with some implementations. The graphical user interface 1100 can present negative and positive variance conditions for corresponding payroll records. For example, a negative value associated with a variance percentage field 1108 can indicate that a value associated with a current amount field 1102 is lower than a value associated with a previous amount field 1104, or that a value associated with a variance amount field 1106 exceeds a configured minimum difference threshold. Additionally, a positive value associated with the variance percentage field 1108 can indicate that a value associated with the current amount field 1102 exceeds a value associated with the previous amount field 1104, or that a value associated with the variance amount field 1106 exceeds a configured upper difference threshold. The variance value field 1106 and variance percentage field 1108 can be evaluated against configured thresholds to identify anomalies, with detected deviations displayed in a reason field 1110 to facilitate operator-assisted payroll validation. The graphical user interface 1100 can be configured to allow a user or an operator to focus on specific categories of variances (e.g., variances for net pay, deductions, allowances, or bonuses). For example, the operator can select net pay from a drill-down menu, causing the graphical user interface 1100 to display records where the net pay amount falls significantly outside the predicted upper or lower thresholds.

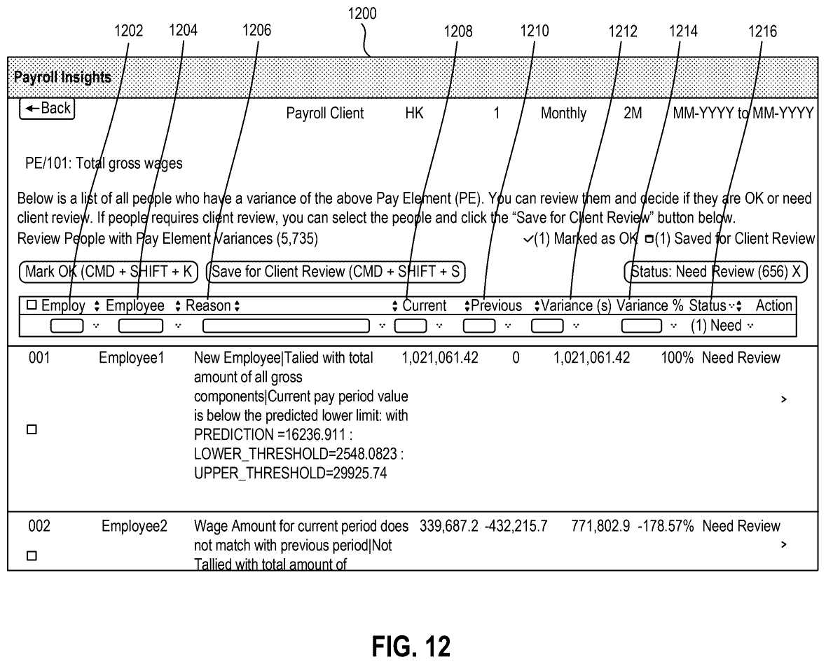

FIG. 12 depicts an example graphical user interface 1200 illustrating a pay element variance dashboard for total gross wages, in accordance with some implementations. The graphical user interface 1200 can allow one or more users or client devices 104 to review aggregated pay element variances across employees for a defined payroll period. The graphical user interface 1200 can present, for each payroll record, one or more data fields, such as an employee identifier field 1202, an employee name field 1204, a reason field 1206, a current amount field 1208, a previous amount field 1210, a variance amount field 1212, a variance percentage field 1214, and a review status field 1216. The graphical user interface 1200 can present predicted wage values and threshold limits generated by the one or more models, as described in connection with FIGS. 1-3. For example, the reason field 1206 can include details such as a predicted value, a lower threshold, and an upper threshold, where a value associated with the current amount field 1208 falls outside the predicted range. The graphical user interface 1200 can be configured to provide a summary view grouped by pay type (e.g., total gross wages).

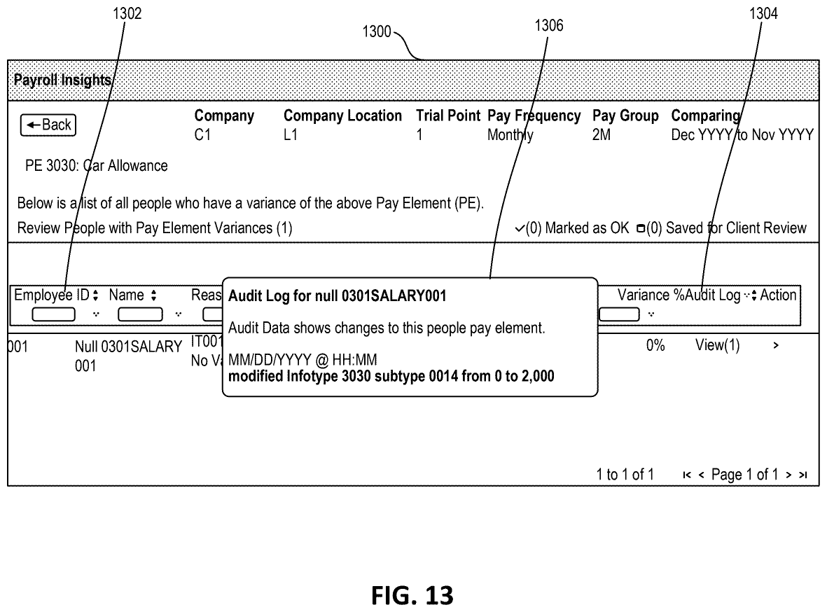

FIG. 13 depicts an example graphical user interface 1300 illustrating an audit log view for a selected pay element, in accordance with some implementations. The graphical user interface 1300 can correspond to an example use case, where an identified variance or detected anomaly prompts a review of a specific pay element, such as pay element 3030 (e.g., car allowance). The graphical user interface 1300 can present an audit log field 1304 in addition to other data field identifiers. The graphical user interface 1300 can be configured to facilitate interaction from the client device 104 with the audit log field 1304. In such instances, the graphical user interface 1300 can be configured to present an audit detail window 1306 or a graphical object displaying modification records associated with the selected pay element variance. For example, as shown, the audit detail window 1306 can present an audit log entry displaying that a pay element in a payroll record associated with an employee identifier field 1302 has been updated from a prior value (e.g., 0) to an updated value (e.g., 2000), including a corresponding timestamp, with contextual information such as whether the employee profile indicated eligibility for the pay element (e.g., presence of a car allowance in the profile). In another example, the audit detail window 1306 can present an audit log entry showing that a change has been recorded, for example, a salary increase, yet the actual payroll record does not indicate the change, thereby resulting in a variance condition where the expected modification is absent or mismatched against the output values. Such a difference between a prior value and an updated value of the pay element, recorded across data modification events or payroll periods, can correspond to the variance or anomaly, depending on the relevancy or severity of the deviation. The graphical user interface 1300 can allow reviewers to trace the source of the variance to the underlying data modification event for auditability and validation of payroll changes.

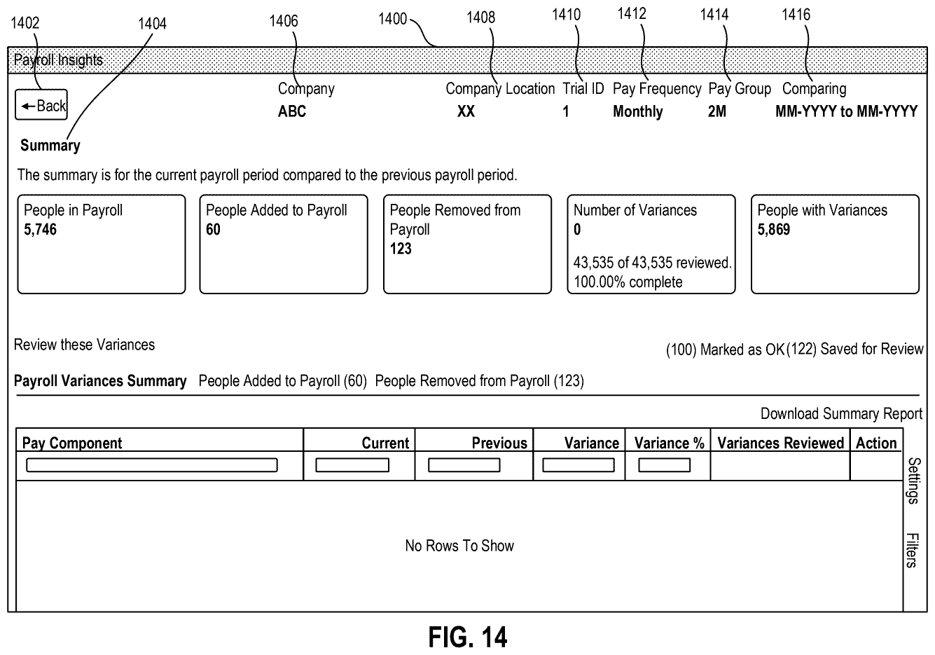

FIG. 14 depicts an example graphical user interface 1400 illustrating a payroll insights dashboard configured to present summary analytics for a payroll period compared with a previous payroll period. The graphical user interface 1400 can present a navigation control 1402 (e.g., back) allowing return to a prior screen, and a summary header 1404 displaying company-level metadata, such as a company name 1406, a company location 1408, a trial identifier 1410, a pay frequency 1412, a pay group 1414, and a comparison period 1416. The graphical user interface 1400 can present indicators of payroll activity, including a total count of people in payroll, people added to payroll, people removed from payroll, number of variances, and people with variances, among others. As described in connection with FIGS. 1-3, the system can detect variances or anomalies and further determine using machine learning whether to take an action on the variance or anomaly, as well as train the models based on user input or feedback collected through the graphical user interface input. Through the graphical user interface 1400, the system can communicate operational insights derived from variance and anomaly detection in a graphically structured format to facilitate user review and interactions.

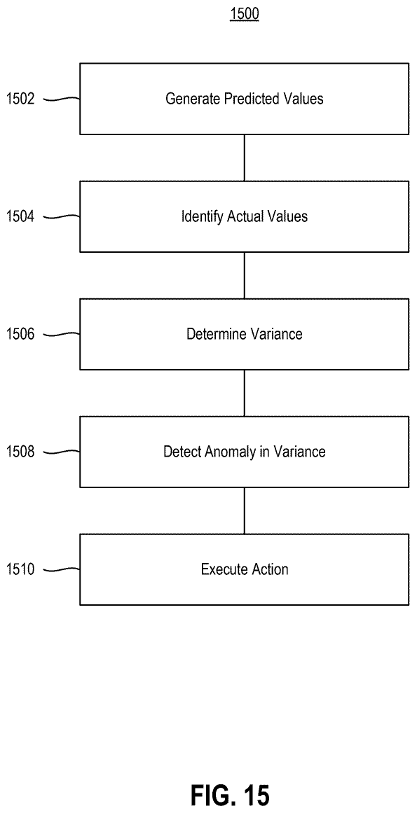

FIG. 15 depicts an example method 1500 for anomaly detection in cross-system operations, in accordance with some implementations. The method 1500 can be implemented using one or more systems or components depicted in FIGS. 1-3 or FIG. 16, including, for example, data processing system 102 or computing system 1600. The method 1500 can include operations 1502-1510. The operations 1502-1510 can be executed in any order or sequence.

At 1502, the method can include generating predicted values. The method can include generating, using one or more models trained with machine learning on data collected from one or more systems of records associated with historical network operations, a plurality of predicted values related to a network operation for an object identifier at a first time interval. The method can include generating the plurality of predicted values using the one or more models configured with conformal prediction. The method can include generating the plurality of predicted values using the one or more models configured with cross-validation across the data associated with the historical network operations. The data collected from the one or more systems of records are associated with the historical network operations for the object identifier.

At 1504, the method can include identifying actual values. The method can include identifying, from the one or more systems of records, a plurality of actual values output responsive to execution of the network operation at the first time interval.

At 1506, the method can include determining a variance. The method can include determining a variance in at least one value of the plurality of actual values based on a comparison of the plurality of actual values and the plurality of predicted values. The method can include determining an upper bound and a lower bound based on the conformal prediction. The method can include determining the variance based on at least one value falling outside the upper bound and the lower bound.

At 1508, the method can include detecting an anomaly in the variance. The method can include detecting, using the one or more models, an anomaly in the variance. The method can include determining, using the one or more models, a severity of the variance and detecting the anomaly based on the severity of the variance. The method can include determining, using the one or more models, a relevance of the variance and detecting the anomaly based on the relevance and the severity of the variance. The method can include detecting the anomaly in the variance based on an audit log for the object identifier. The method can include triggering, based on a load balancing technique, an anomaly detection process for the network operation at the first time interval. The method can include executing, responsive to the trigger, the anomaly detection process to detect the anomaly in the variance.

At 1510, the method can include executing an action based on the anomaly. The method can include executing, responsive to detection of the anomaly, an action to update the one or more models based on the anomaly. The method can include executing the action, including to provide, for display via a graphical user interface, an indication of the anomaly. The method can include receiving, responsive to an interaction with the graphical user interface, an indication to invalidate the anomaly, where invalidating the anomaly validates the variance. The method can include updating the one or more models based on the invalidation of the anomaly to control a performance of the one or more models with detection of anomalies associated with subsequent network operations. The method can include receiving, responsive to an interaction with the graphical user interface, an indication to validate the anomaly, where validating the anomaly invalidates the variance. The method can include updating the one or more models based on the validation of the anomaly to control a performance of the one or more models with detection of anomalies associated with subsequent network operations. The method can include receiving the interaction, including natural language text input, and updating the one or more models based on the natural language text input.

FIG. 16 depicts a block diagram of a computing system 1600 for implementing the embodiments of the technical solutions discussed herein, in accordance with various aspects. FIG. 16 illustrates a block diagram of an example computing system 1600, which can also be referred to as the computer system 1600. Computing system 1600 can be used to implement elements of the systems and methods described and illustrated herein. Computing system 1600 can be included in and run any device (e.g., a server, a computer, a cloud computing environment or a data processing system).

Computing system 1600 can include at least one bus data bus 1605 or other communication device, structure or component for communicating information or data. Computing system 1600 can include at least one processor 1610 or processing circuit coupled to the data bus 1605 for executing instructions or processing data or information. Computing system 1600 can include one or more processors 1610 or processing circuits coupled to the data bus 1605 for exchanging or processing data or information along with other computing systems 1600. Computing system 1600 can include one or more main memories 1615, such as a random access memory (RAM), dynamic RAM (DRAM), cache memory or other dynamic storage device, which can be coupled to the data bus 1605 for storing information, data and instructions to be executed by the processor(s) 1610. Main memory 1615 can be used for storing information (e.g., data, computer code, commands or instructions) during execution of instructions by the processor(s) 1610.

Computing system 1600 can include one or more read only memories (ROMs) 1620 or other static storage device 1625 coupled to the bus 1605 for storing static information and instructions for the processor(s) 1610. Storage devices 1625 can include any storage device, such as a solid-state device, magnetic disk or optical disk, which can be coupled to the data bus 1605 to persistently store information and instructions.

Computing system 1600 can be coupled via the data bus 1605 to one or more output devices 1635, such as speakers or displays (e.g., liquid crystal display or active matrix display) for displaying or providing information to a user. Input devices 1630, such as keyboards, touch screens or voice interfaces, can be coupled to the data bus 1605 for communicating information and commands to the processor(s) 1610. Input device 1630 can include, for example, a touch screen display (e.g., output device 1635). Input device 1630 can include a cursor control, such as a mouse, a trackball, or cursor direction keys, for communicating direction information and command selections to the processor(s) 1610 for controlling cursor movement on a display.

The processes, systems and methods described herein can be implemented by the computing system 1600 in response to the processor 1610 executing an arrangement of instructions contained in main memory 1615. Such instructions can be read into main memory 1615 from another computer-readable medium, such as the storage device 1625. Execution of the arrangement of instructions contained in main memory 1615 causes the computing system 1600 to perform the illustrative processes described herein. One or more processors 1610 in a multi-processing arrangement can also be employed to execute the instructions contained in main memory 1615. Hard-wired circuitry can be used in place of or in combination with software instructions together with the systems and methods described herein. Systems and methods described herein are not limited to any specific combination of hardware circuitry and software.

Although an example computing system has been described in FIG. 16, the subject matter, including the operations described in this specification, can be implemented in other types of digital electronic circuitry, or in computer software, firmware, or hardware, including the structures described in this specification and their structural equivalents, or in combinations of one or more of them.

The foregoing examples have been provided merely for the purpose of explanation and are in no way to be construed as limiting of the present description. While aspects of the technical solutions described herein have been described with reference to an exemplary embodiment, it is understood that the words which have been used herein are words of description and illustration, rather than words of limitation. Changes can be made, within the purview of the appended claims, as presently stated and as amended, without departing from the scope and spirit of the present description in its aspects. Although aspects of the technical solutions described herein have been described herein with reference to particular means, materials and embodiments, the present description is not intended to be limited to the particulars described herein; rather, the present description extends to all functionally equivalent structures, methods and uses, such as are within the scope of the appended claims.

The subject matter and the operations described in this specification can be implemented in digital electronic circuitry, or in computer software, firmware, or hardware, including the structures described in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device,” “component” or “data processing apparatus” or the like encompass various apparatuses, devices, and machines for processing data, including, by way of example, a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, application, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media, and memory devices, including, by way of example, semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements, and features discussed in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently described systems or methods, their components, acts, or elements to single or plural configurations. References to any act or element being based on any information, act or element can include implementations where the act or element is based at least in part on any information, act, or element.

Any implementation described herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations described herein.

References to “or” can be construed as inclusive so that any terms described using “or” can indicate any of a single, more than one, and all of the described terms. References to at least one of a conjunctive list of terms can be construed as an inclusive OR to indicate any of a single, more than one, and all of the described terms. For example, a reference to “at least one of ‘A’ and ‘B’” can include only ‘A,’ only ‘B,’ as well as both ‘A’ and ‘B.’ Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as substitutions, changes and omissions can be made in the design, operating conditions and arrangement of the described elements and operations without departing from the scope of the present description.

What is claimed is:

1. A system of anomaly detection in cross-system operations, the system comprising:
one or more processors, coupled with memory, to:
generate, using one or more models trained with machine learning on data collected from one or more systems of records associated with historical network operations, a plurality of predicted values related to a network operation for an object identifier at a first time interval;
identify, from the one or more systems of records, a plurality of actual values output responsive to execution of the network operation at the first time interval;
determine a variance in at least one value of the plurality of actual values based on a comparison of the plurality of actual values and the plurality of predicted values;
detect, using the one or more models, an anomaly in the variance; and
execute, responsive to detection of the anomaly, an action to update the one or more models based on the anomaly.

2. The system of claim 1, wherein the one or more processors further:
generate the plurality of predicted values using the one or more models configured with conformal prediction.

3. The system of claim 2, wherein the one or more processors further:
generate the plurality of predicted values using the one or more models configured with cross-validation across the data associated with the historical network operations.

4. The system of claim 2, wherein the one or more processors further:
determine an upper bound and a lower bound based on the conformal prediction; and
determine the variance based on the at least one value falling outside the upper bound and the lower bound.

5. The system of claim 1, wherein the data collected from the one or more systems of records are associated with the historical network operations for the object identifier.

6. The system of claim 1, wherein the one or more processors further:
determine, using the one or more models, a severity of the variance; and
detect the anomaly based on the severity of the variance.

7. The system of claim 6, wherein the one or more processors further:
determine, using the one or more models, a relevance of the variance; and
detect the anomaly based on the relevance and the severity of the variance.

8. The system of claim 1, wherein the one or more processors further:
execute the action comprising to provide, for display via a graphical user interface, an indication of the anomaly;
receive, responsive to an interaction with the graphical user interface, an indication to invalidate the anomaly, wherein invalidating the anomaly validates the variance; and
update the one or more models based on the invalidation of the anomaly to control a performance of the one or more models with detection of anomalies associated with subsequent network operations.

9. The system of claim 8, wherein the one or more processors further:
receive the interaction comprising natural language text input; and
update the one or more models based on the natural language text input.

10. The system of claim 1, wherein the one or more processors further:
execute the action comprising to provide, for display via a graphical user interface, an indication of the anomaly;
receive, responsive to an interaction with the graphical user interface, an indication to validate the anomaly, wherein validating the anomaly invalidates the variance; and
update the one or more models based on the validation of the anomaly to control a performance of the one or more models with detection of anomalies associated with subsequent network operations.

11. The system of claim 1, wherein the one or more processors further:
trigger, based on a load balancing technique, an anomaly detection process for the network operation at the first time interval; and
execute, responsive to the trigger, the anomaly detection process to detect the anomaly in the variance.

12. The system of claim 1, wherein the one or more processors further:
detect the anomaly in the variance based on an audit log for the object identifier.

13. A method of anomaly detection in cross-system operations, the method comprising:
generating, by one or more processors coupled with memory, using one or more models trained with machine learning on data collected from one or more systems of records associated with historical network operations, a plurality of predicted values related to a network operation for an object identifier at a first time interval;
identifying, by the one or more processors, from the one or more systems of records, a plurality of actual values output responsive to execution of the network operation at the first time interval;
determining, by the one or more processors, a variance in at least one value of the plurality of actual values based on a comparison of the plurality of actual values and the plurality of predicted values;
detecting, by the one or more processors, using the one or more models, an anomaly in the variance; and
executing, by the one or more processors, responsive to detection of the anomaly, an action to update the one or more models based on the anomaly.

14. The method of claim 13, comprising:
generating, by the one or more processors, the plurality of predicted values using the one or more models configured with conformal prediction.

15. The method of claim 14, comprising:
generating, by the one or more processors, the plurality of predicted values using the one or more models configured with cross-validation across the data associated with the historical network operations.

16. The method of claim 13, wherein the data collected from the one or more systems of records are associated with the historical network operations for the object identifier.

17. The method of claim 13, comprising:
determining, by the one or more processors, using the one or more models, a severity of the variance; and
detecting, by the one or more processors, the anomaly based on the severity of the variance.

18. The method of claim 13, comprising:
executing, by the one or more processors, the action comprising to provide, for display via a graphical user interface, an indication of the anomaly;
receiving, by the one or more processors, responsive to an interaction with the graphical user interface, an indication to invalidate the anomaly, wherein invalidating the anomaly validates the variance; and
updating, by the one or more processors, the one or more models based on the invalidation of the anomaly to control a performance of the one or more models with detection of anomalies associated with subsequent network operations.

19. A non-transitory computer-readable medium storing processor executable instructions that, when executed by one or more processors, cause the one or more processors to:
generate, using one or more models trained with machine learning on data collected from one or more systems of records associated with historical network operations, a plurality of predicted values related to a network operation for an object identifier at a first time interval;
identify, from the one or more systems of records, a plurality of actual values output responsive to execution of the network operation at the first time interval;
determine a variance in at least one value of the plurality of actual values based on a comparison of the plurality of actual values and the plurality of predicted values;
detect, using the one or more models, an anomaly in the variance; and
execute, responsive to detection of the anomaly, an action to update the one or more models based on the anomaly.

20. The non-transitory computer-readable medium of claim 19, wherein the processor executable instructions further include instructions to:
generate the plurality of predicted values using the one or more models configured with conformal prediction.
